(19) United States
(12) Patent Application Publication
(10) Pub. No.: US 2026/0040120 A1
(43) Pub. Date: Feb. 5, 2026

(54) GENERATING A MEASUREMENT REPORT USING ONE OF MULTIPLE AVAILABLE ARTIFICIAL INTELLIGENCE MODELS

(71) Applicant: Lenovo (Singapore) Pte. Limited, Singapore (SG)

(72) Inventors: Ahmed Hindy, Aurora, IL (US); Vahid Pourahmadi, München (DE); Venkata Srinivas Kothapalli, Ottawa (CA); Vijay Nangia, Woodridge, IL (US); Hossein Bagheri, Urbana, IL (US)

(73) Assignee: Lenovo (Singapore) Pte. Limited, Singapore (SG)

(21) Appl. No.: 19/099,985

(22) PCT Filed: Jul. 26, 2023
(86) PCT No.: PCT/IB2023/057590

§ 371 Date: Jan. 30, 2025

Related U.S. Application Data
(60) Provisional application No. 63/394,814, filed on Aug. 3, 2022.
(60) Provisional application No. 63/394,822, filed on Aug. 3, 2022.
(60) Provisional application No. 63/394,857, filed on Aug. 3, 2022.

(51) Int. Cl. H04W 24/10; H04W 24/02

(52) U.S. Cl. CPC H04W 24/10; H04W 24/02

(57) ABSTRACT

Various aspects of the present disclosure relate to a use equipment (UE) configured with multiple artificial intelligence (AI) models each of which has been configured (e.g., trained) based on training data sets corresponding to one or more of different conditions, such as location of the UE, orientation of the UE, whether the UE is indoors or outdoors, whether the UE is line-of-sight or non-line-of-sight with a base station, and so forth. A network entity (e.g., a gNB) configures the UE with a set of reference signals for measurement of at least one quantity. The UE generates the measurement report based at least in part on the set of reference signals and one of the multiple AI models, and transmits the measurement report to the network entity (e.g., gNB).

### RELATED APPLICATION

This application claims priority to U.S. Patent Application Ser. No. 63/394,814 filed Aug. 3, 2022 entitled “ARTIFICIAL INTELLIGENCE FOR CHANNEL STATE INFORMATION,” U.S. Patent Application Ser. No. 63/394,822 filed Aug. 3, 2022 entitled “OPERATION OF A TWO-SIDED MODEL,” and U.S. Patent Application Ser. No. 63/394,857 filed Aug. 3, 2022 entitled “GENERATING A MEASUREMENT REPORT USING ONE OF MULTIPLE AVAILABLE ARTIFICIAL INTELLIGENCE MODELS,” the disclosures of which are incorporated by reference herein in their entirety.

### TECHNICAL FIELD

The present disclosure relates to wireless communications, and more specifically to generation of measurement reports using one of multiple available artificial intelligence (AI) models.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In some cases, the wireless communication system may support measurement and reporting operations. For example, a UE may perform channel measurements and transmit a report, to a base station, such as a channel state information (CSI) report indicating a result of the channel measurements (e.g., CSI). In some cases, one or more of the measurement and reporting operations may occur at various times or in response to various events.

### SUMMARY

The present disclosure relates to methods, apparatuses, and systems that support a UE configured with multiple AI models each of which has been configured (e.g., trained) based on training data sets corresponding to one or more of different conditions, such as location of the UE, orientation of the UE, whether the UE is indoors or outdoors, whether the UE is line-of-sight (LoS) or non-line-of-sight (NLoS) with a base station, and so forth. A network entity (e.g., a gNB) configures the UE with a set of reference signals for measurement of at least one quantity. The UE generates the measurement report based at least in part on the set of reference signals and one of the multiple AI models. The measurement report is then transmitted to the network entity (e.g., a gNB). By using one of multiple AI models that are available to the UE to generate the measurement report, different AI models can be generated (e.g., trained) corresponding to different conditions, allowing the AI models to more accurately generate measurement reports (e.g., channel state information (CSI) measurement reports) based on the current conditions of the UE at the time the measurement report is generated.

Some implementations of the method and apparatuses described herein may further include to: receive, from a network entity, a first signaling indicating a configuration for measurement and reporting of at least one quantity, the configuration indicating a set of reference signals for measurement of the at least one quantity and indicating to report one or more parameters corresponding to the at least one quantity; generate a measurement report, including the one or more parameters corresponding to the at least one quantity, based at least in part on the set of reference signals and a selection of an AI model from multiple AI models, each AI model of the multiple AI models having been configured prior to receiving the first signaling; and transmit, to the network entity, a second signaling indicating the measurement report.

In some implementations of the method and apparatuses described herein, at least one of: the measurement report comprises a CSI measurement report; the configuration comprises a CSI reporting configuration message; the at least one quantity comprises a CSI quantity; and the set of reference signals comprises at least one CSI reference signal (CSI-RS) received over a CSI-RS resource. Additionally or alternatively, the selection of the AI model is based on at least one of: a number of frequency-domain basis indices corresponding to one of a precoding matrix or a channel matrix; a number of spatial-domain basis indices corresponding to one of a precoding matrix or a channel matrix; a ratio of a function of power gain of a first subset of the spatial-domain basis indices to a function of power gain of a second subset of the spatial-domain basis indices; and a ratio of a function of power gain of a first subset of the frequency-domain basis indices to a function of power gain of a second subset of the frequency-domain basis indices. Additionally or alternatively, the at least one CSI-RS corresponds to multiple CSI-RS ports. Additionally or alternatively, the method and apparatuses are further to: receive, from the network entity, a third signaling indicating one or more parameters corresponding to the selection of the AI model from the multiple AI models; and generate the measurement report based at least in part on the AI model and the one or more parameters that correspond to the AI model. Additionally or alternatively, the one or more parameters are at least one of: signaled via higher-layer signaling, signaled over multiple time units, and common for multiple network nodes. Additionally or alternatively, the method and apparatuses are further to: transmit, to the network entity, a third signaling indicating at least one parameter corresponding to the selection of the AI model from the multiple AI models. Additionally or alternatively, the third signaling includes at least one of a CSI report or an AI-based report, and wherein the third signaling is transmitted over multiple time units. Additionally or alternatively, the method and apparatuses are further to: transmit, to the network entity, a third signaling indicating a set of parameters corresponding to a subset of coefficients associated with a subset of CSI dimensions having one or more coefficients comprising an adjusted value. Additionally or alternatively, the set of parameters corresponds to a bitmap. Additionally or alternatively, the adjusted value is zero. Additionally or alternatively, the set of parameters corresponds to a set of amplitude values that includes a zero value. Additionally or alternatively, the adjusted value is one of the set of amplitude values. Additionally or alternatively, the set of parameters are adjusted based on a codebook subset restriction configuration.

Some implementations of the method and apparatuses described herein may further include to: transmit, to a UE, a first signaling indicating a configuration of the UE for measurement and reporting of at least one quantity, the configuration indicating a set of reference signals for measurement of the at least one quantity and indicating to report one or more parameters corresponding to the at least one quantity; and receive, from the UE, a second signaling indicating a measurement report, including the one or more parameters corresponding to the at least one quantity, generated based at least in part on the set of reference signals and a selection of an artificial intelligence (AI) model from multiple AI models, each AI model of the multiple AI models having been configured prior to receiving the first signaling.

In some implementations of the method and apparatuses described herein, at least one of: the measurement report comprises a CSI measurement report; the configuration comprises a CSI reporting configuration message; the at least one quantity comprises a CSI quantity; and the set of reference signals comprises at least one CSI-RS transmitted over a CSI-RS resource. Additionally or alternatively, the selection of the AI model is based on at least one of: a number of frequency-domain basis indices corresponding to one of a precoding matrix or a channel matrix; a number of spatial-domain basis indices corresponding to one of a precoding matrix or a channel matrix; a ratio of a function of power gain of a first subset of the spatial-domain basis indices to a function of power gain of a second subset of the spatial-domain basis indices; and a ratio of a function of power gain of a first subset of the frequency-domain basis indices to a function of power gain of a second subset of the frequency-domain basis indices. Additionally or alternatively, the at least one CSI-RS corresponds to multiple CSI-RS ports. Additionally or alternatively, the method and apparatuses are further to: transmit, to the UE, a third signaling indicating one or more parameters corresponding to the selection of the AI model from the multiple AI models; and receive, from the UE, the measurement report generated based at least in part on the AI model and the one or more parameters that correspond to the one AI model. Additionally or alternatively, the one or more parameters are at least one of: signaled via higher-layer signaling, signaled over multiple time units, and common for multiple network nodes. Additionally or alternatively, the method and apparatuses are further to: receive, from the UE, third signaling indicating at least one parameter corresponding to the selection of the AI model from the multiple AI models. Additionally or alternatively, the third signaling includes at least one of a channel state information report or an AI-based report, and wherein the third signaling is transmitted over multiple time units. Additionally or alternatively, the method and apparatuses are further to: receive, from the UE, third signaling indicating a set of parameters corresponding to a subset of coefficients associated with a subset of CSI dimensions having one or more coefficients comprising an adjusted value. Additionally or alternatively, the set of parameters corresponds to a bitmap. Additionally or alternatively, the adjusted value is zero. Additionally or alternatively, the set of parameters corresponds to a set of amplitude values that includes a zero value. Additionally or alternatively, the adjusted value is one of the set of amplitude values. Additionally or alternatively, the set of parameters are adjusted based on a codebook subset restriction configuration.

### BRIEF DESCRIPTION OF THE DRAWINGS

FIG. 1 illustrates an example of a wireless communications system that supports generating a measurement report using one of multiple available artificial intelligence models in accordance with aspects of the present disclosure.

FIG. 2 illustrates a system that implements at least some CSI feedback mechanisms.

FIG. 3 illustrates an aperiodic trigger state defining a list of CSI report settings.

FIG. 4 illustrates an information element for pertaining to CSI reporting.

FIG. 5 illustrates an information element for RRC configuration for non-zero power CSI reference signal (NZP-CSI-RS)/CSI interference management (CSI-IM) resources.

FIG. 6 illustrates a scenario for partial CSI omission for PUSCH-Based CSI.

FIGS. 7a, 7b illustrate respectively a UE subsystem and a network subsystem of a CSI system that supports generating a measurement report using one of multiple available artificial intelligence models in accordance with aspects of the present disclosure.

FIGS. 8 and 9 illustrate an example of a block diagram of a device that supports generating a measurement report using one of multiple available artificial intelligence models in accordance with aspects of the present disclosure.

FIGS. 10 through 21 illustrate flowcharts of methods that support generating a measurement report using one of multiple available artificial intelligence models in accordance with aspects of the present disclosure.

### DETAILED DESCRIPTION

A UE oftentimes feeds back information to a network entity (e.g., a gNB) using a measurement report, such as feeding back CSI information using a CSI measurement report. Given the nature of the information (e.g., real numbers), the measurement reports can be very large. One way to reduce the size of the measurement reports is to compress the data in the measurement reports, such as by using linear compression. However, this compression results typically results in reducing the data size but at the expense of decreased accuracy (or increased distortion) in the data.

Using the techniques discussed herein, a UE includes multiple AI models (also referred to as machine learning (IL) models) each of which has been trained based on training data sets corresponding to one or more of different conditions, such as location of the UE, orientation of the UE, whether the UE is indoors or outdoors, whether the UE is LoS or NLoS with a base station, and so forth. The AI models are trained, for example, by a network entity (e.g., a gNB) or by the UE. A network entity (e.g., a gNB) configures the UE with a set of reference signals for measurement of at least one quantity (e.g., a CSI quantity). The UE generates the measurement report (e.g., a CSI measurement report) based at least in part on the set of reference signals and one of the multiple AI models. The UE selects which of the multiple AI models to use to generate the measurement report based at least in part on the current conditions at the UE (e.g., selects the AI model that was trained using training data sets that match the current conditions at the UE). The measurement report is then transmitted to the network entity (e.g., a gNB).

By using one of multiple AI models that are available to the UE to generate the measurement report, the different AI models having been generated (e.g., trained) corresponding to different conditions, the AI models are able to more accurately generate measurement reports (e.g., CSI measurement reports) based on the current conditions of the UE at the time the measurement report is generated. Furthermore, the multiple AI models can be trained using various channel samples rather than using conventional CSI feedback (e.g., Type-I and Type-II codebook). By avoiding using conventional CSI feedback, compression that is inherent in the conventional feedback is not introduced into the AI models. Rather, the AI models are trained to design or determine a proper compression scheme for CSI feedback. Additionally, the UE need not change or switch to using different CSI reporting configurations to accommodate for variations of the channel distributions. This allows the UE to maintain a consistent CSI reporting configuration and neither the UE nor the network entity need to attempt to accommodate any of the multiple reporting configurations.

Aspects of the present disclosure are described in the context of a wireless communications system. Aspects of the present disclosure are further illustrated and described with reference to device diagrams and flowcharts.

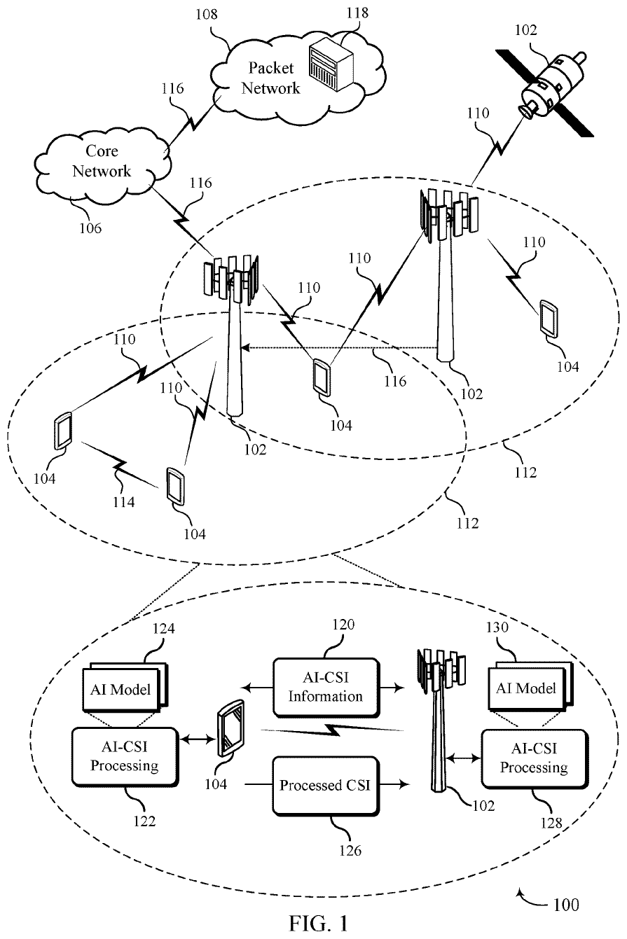

FIG. 1 illustrates an example of a wireless communications system 100 that supports generating a measurement report using one of multiple available artificial intelligence models in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FRI (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FRI may be associated with one or multiple numerologies (e.g., at least three numerologies). For example, FRI may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for generating a measurement report using one of multiple available artificial intelligence models, a UE 104 and a network entity 102 can interact to enable efficient generation of CSI by the UE 104 and provision of the CSI to the network entity 102. For instance, the network entity 102 and the UE 104 can exchange AI-CSI information 120 that enables different aspects of generating a measurement report using one of multiple available artificial intelligence models to be implemented by the network entity 102 and the UE 104. Examples of the AI-CSI information include configuration information for the UE 104 to measure and report at least one quantity, such as any quantity included in a CSI report. The AI-CSI information 120 can also include different configurations and settings applied by the UE 104, such as part of processing CSI as further described below.

Further, the UE 104 determines CSI for a channel between the network entity 102 and the UE 104 (e.g., based on a reference signal transmitted by the network entity 102) and performs AI-CSI processing 122 to generate processed CSI 126. The AI-CSI processing 122, for instance, includes applying AI processing based on one of multiple AI models 124 (e.g., multiple neural networks) to CSI to generate the processed CSI 126 (e.g., a CSI measurement report). Various details and aspects of the AI-CSI processing 122 and the processed CSI 126 are detailed throughout this disclosure.

The network entity 102 receives the processed CSI 126 and performs AI-CSI processing 128 using the processed CSI 126. For instance, the network entity 102 uses one of multiple AI models 130 (e.g., multiple neural networks) to perform the AI-CSI processing 128 to extract relevant CSI-related data from the processed CSI 126. In at least some implementations the network entity 102 implements portions of the AI-CSI processing 128 utilizing configuration information received from the UE 104, such as part of the AI-CSI information 120.

In one or more implementations, the AI-CSI processing 122 is based on multiple AI models that are trained based on one or more of different conditions, such as location of the UE 104, orientation of the UE 104, whether the UE 104 is indoors or outdoors, whether the UE 104 is LoS or NLoS with a base station, and so forth. The UE 104 receives, from the network entity 102, a configuration indicating a set of reference signals for measurement of at least one quantity based on a set of reference signals (e.g., received from the network entity 102). The AI-CSI processing 122 generates a measurement report (e.g., a CSI measurement report) based at least in part on the set of reference signals and one of the multiple AI models and transmits the measurement report to the network entity 102 as processed CSI 126. The AI-CSI processing 122 selects which of the multiple AI models to use to generate the measurement report based at least in part on the current conditions at the UE 104. The AI-CSI processing 122 selects the AI model that was trained using training data sets that match the current conditions at the UE 104. E.g., for training the AI models, training data sets are partitioned into multiple subsets based on various criteria related to one or more conditions of the UE 104. Each subset corresponds to and is used to train an AI model. The AI-CSI processing 122 selects the AI model that corresponds to whichever subset the current conditions at the UE 104 would put the UE 104 in.

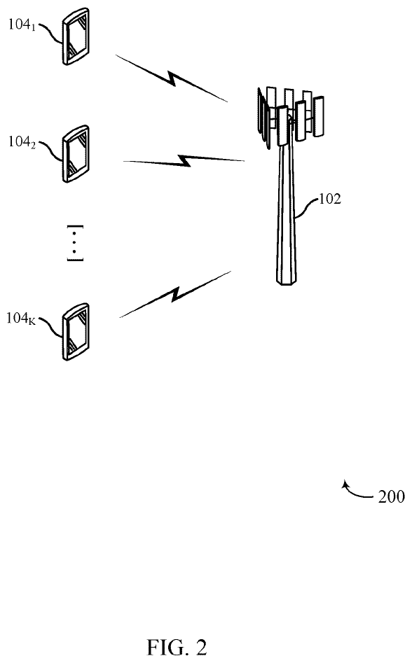

FIG. 2 illustrates a system 200 that implements at least some CSI feedback mechanisms. The system 200 includes a network entity 102 (e.g., a gNB) equipped with M antennas. Further, the system 200 includes UEs 104 including a UE 1041, a UE 104₂, and a UE 104_{K}. In the discussion below, the UEs 104 include K UEs denoted by U₁, U₂, . . . , U_{K} each having N antennas.

$${H}_{l}^{k} ( t )$$

denotes a channel at time t over frequency band (or subcarrier or subband or physical resource block (PRB) or sub-PRB or PRB-group or bandwidth part in a channel bandwidth) l, l ∈ {1,2, . . . , L}, between B₁ and Uₖ which is a matrix of size N×M with complex entries, e.g.,

$${H}_{l}^{k} ( t ) ∈ {ℂ}^{N \times M} .$$

At time t and frequency band 1, the network entity 102 can be configured to transmit a message

$${x}_{l}^{k} ( t )$$

to user Uₖ where k={1,2, . . . , K}while the network entity 102 uses

$${w}_{l}^{k} ( t ) ∈ {ℂ}^{M \times 1}$$

as the precoding vector. The received signal at Uₖ, yₗ^{k}(t), can be written as:

$${y}_{l}^{k} ( r ) = {H}_{l}^{k} ( t ) {w}_{l}^{k} ( t ) {x}_{l}^{k} ( t ) + {n}_{l}^{k} ( i ) where {n}_{l}^{k} ( t )$$

represents the noise vector at the receiver.

Further to the system 200, to improve the achievable rate of the link, the network entity 102 can select

$${w}_{l}^{k} ( t )$$

that maximizes some metric such as the received signal to noise ratio (SNR). Several schemes have been proposed for optimal selection of

$${w}_{l}^{k} ( t )$$

where most of them utilize some knowledge about

$${H}_{l}^{k} ( t ) .$$

The network entity 102 can obtain information about

$${H}_{l}^{k} ( t )$$

by direct measurement (e.g., in time-division duplexing (TDD) mode and assuming reciprocity of the channel direct measurement of the uplink channel, in frequency-division duplexing (FDD) mode assuming reciprocity of some of the large scale parameters such as AoA/AoD), or indirectly using the information that the UE sends to the gNB (e.g., in FDD mode). In the latter case, a large amount of feedback may be needed to send accurate information about

$${H}_{l}^{k} ( t ) .$$

Several methods have been proposed trying to reduce the required CSI feedback. One idea is to try to use the correlation between different entries of

$${H}_{k}^{l} ( t ) ,$$

e.g., between a) different Tx-Rx antenna pairs, b) between different frequency bands, c) between different time slots.

In at least some aspects of the present disclosure, implementations consider a single time slot and focus on transmitting information regarding a channel between a user k and a network entity over multiple frequency bands. Further, implementations can utilize multiple time slots, such as by replacing a frequency domain with a time domain and/or creating a joint time-frequency domain. For purposes of the discussion herein

$${H}_{l}^{k} ( t )$$

may be denoted using Hₗ.

Further, H may be defined as a matrix of size N×M×L which can be constructed by stacking Hₗ for multiple frequency bands, e.g., the entries at H[n, m, l]are equal to Hₗ [n, m]. Thus, a UE may send information about N×M×L complex numbers to a network entity.

Accordingly, in aspects of this disclosure, implementations enable a UE to transmit information about H to a network entity with a limited number of feedback bits. For instance, implementations to enable a UE to efficiently compress and send CSI information, such as H, to the gNB.

Thus, implementations discussed herein enable reduction of feedback information generated by a UE and/or transmitted to a network entity. For instance, data driven schemes for data compression are provided such as by an encoder at a UE which computes a latent representation of input data. The latent representation can be quantized and sent to a network entity and the network entity applies a decoder to the quantized latent representation to reconstruct a desired output. The implementation of different model features such as at a UE and a network entity, and associated architectures, can be referred to herein as two-sided models. Further, implementation details are provided such as for training, deploying, and operating two-sided models in settings that involve different types of UEs and/or different network parameters, such as when a number of possible feedback bits may change.

In some wireless communications systems it is considered that a gNB is equipped with a two-dimensional (2D) antenna array with N₁, N₂ antenna ports per polarization placed horizontally and vertically, and communication occurs over N₃ PMI sub-bands. A precoding matrix indicator (PMI) subband consists of a set of resource blocks, each resource block consisting of a set of subcarriers. In such case, 2N₁N₂ CSI-RS ports are utilized to enable downlink channel estimation with high resolution for NR Rel. 15 Type-II codebook. In order to reduce the uplink feedback overhead, a Discrete Fourier transform (DFT)-based CSI compression of the spatial domain is applied to L dimensions per polarization, where L<N₁N₂. In the sequel the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer/takes on the form:

$${W}_{l} = {W}_{1} {W}_{2 , l} ,$$

where W₁ is a 2N₁N₂×2L block-diagonal matrix (L<N₁N₂) with two identical diagonal blocks, e.g.:

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ oversampling factors are considered for the 2D DFT matrix from which matrix B is drawn. Note that W₁ is common across all layers. W_{2,l} is a 2Lx N₃ matrix, where the i^{th} column corresponds to the linear combination coefficients of the 2L beams in the i^{th} sub-band. Only the indices of the L selected columns of B may be reported, along with the oversampling index taking on O₁O₂ values. Note that W_{2,l} are independent for different layers.

In some wireless communications systems, for Type-II Port Selection codebook, only K (where K<2N₁N₂) beamformed CSI-RS ports are utilized in downlink transmission, in order to reduce complexity. The. The K×N₃ codebook matrix per layer takes on the form

$${W}_{l} = {W}_{1}^{PS} {W}_{2 , l} ,$$

Here, W₂ follow the same structure as the conventional NR Rel. 15 Type-II Codebook, and are layer specific.

$${W}_{1}^{PS}$$

is a Kb×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{P S} {d}_{P S} + L - 1 , K / 2 )}^{( K / 2 )} ] ,$$

$$where {e}_{i}^{( K )}$$

is a standard unit vector with a 1 at the i^{th} location. Here d_{PS} is an RRC parameter which takes on the values {1,2,3,4}under the condition d_{PS}<min(K 2, L), whereas m_{PS} takes on the values

$$\{ 0 , … , ⌈ \frac{K}{2 {d}_{P S}} ⌉ - 1 \}$$

and is reported as part of the uplink CSI feedback overhead. W₁ is common across all layers.

For K=16, L=4 and d_{PS}=1, the 8 possible realizations of E corresponding to m_{PS}={0,1, . . . ,7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook is the baseline codebook for NR, with a variety of configurations. The most common utility of Rel. 15 Type-I codebook is a special case of NR Rel. 15 Type-II codebook with L=1 for RI=1,2, wherein a phase coupling value is reported for each sub-band, e.g., W_{2,l} is 2×N₃, with the first row equal to [1, 1, . . . , 1]and the second row equal to [e^{j2πøθ0}, . . . , e^{j2πøN}₃−1]. Under specific configurations, ϕ₀=ϕ₁ . . . =ϕ, e.g., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

For NR Rel. 16 Type-II codebook, some wireless communications systems consider that a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable downlink channel estimation with high resolution for NR Rel. 16 Type-II codebook. In order to reduce the uplink feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ oversampling factors are considered for the 2D DFT matrix from which matrix B is drawn. Note that W₁ is common across all layers. W_{f} is an N₃×A matrix (M<N₃) with columns selected from a critically-sampled size-N₃ DFT matrix, as follows:

$${w}_{f , l} = [ {f}_{{k}_{0}} {f}_{{k}_{1}} … {f}_{{k}_{{M}^{′} - 1}} ] , 0 \leq {k}_{i} \leq {N}_{3} - 1 ,$$

$${f}_{k} = {[ 1 {e}^{- j \frac{2 π k}{{N}_{3}}} … {e}^{- j \frac{2 π k ( {N}_{3} - 1 )}{{N}_{3}}} ]}^{T} .$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×V matrix W₂ represents the linear combination coefficients (LCCs) of the spatial and frequency DFT-basis vectors. Both W₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βM]−1 coefficients (along with the indices of selected L, M DFT vectors) are reported per layer, leading to significant reduction in CSI report size, compared with reporting 2N₁N₂×N₃−1 coefficients' information.

For Type-II Port Selection codebook, only K (where K<2N₁N₂) beamformed CSI-RS ports are utilized in downlink transmission, in order to reduce complexity. The. The K×N₃ codebook matrix per layer takes on the form:

$${W}_{l} = {W}_{1}^{PS} {\tilde{W}}_{2 , l} {W}_{f , l}^{H} .$$

Here, \tilde{W}_{2,l} and \tilde{W}_{f,l} follow the same structure as the conventional NR Rel. 16 Type-II Codebook, where both are layer specific. The matrix

$${W}_{1}^{PS}$$

is is a K×2L block-diagonal matrix with the same structure as that in the NR Rel. 15 Type-II Port Selection Codebook.

In some wireless communications systems, Rel. 17 Type-II Port Selection codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,1} and W_{f}, follow the same structure as the conventional NR Rel. 16 Type-II Codebook, however M is limited to 1,2 only, with the network configuring a window of size N={2,4} for M=2. Moreover, the bitmap is reported unless μ=1 and the UE reports all the coefficients for a rank up to a value of two.

For codebook reporting, a codebook report is partitioned into two parts based on the priority of information reported. Each part is encoded separately (Part 1 has a possibly higher code rate). Below we list the parameters for NR Rel. 16 Type-II codebook.

Content of CSI report can include:

$$Part 1 : RI + CQI + Total number of coefficients$$

$$Part 2 : SD basis indicator + FD basis indicator / layer + Bitmap / layer + Coefficient Amplitude info / layer + Coefficient Phase info / layer + Strongest coefficient indicator / layer$$

Furthermore, Part 2 CSI can be decomposed into sub-parts each with different priority (higher priority information listed first). Such partitioning is required to allow dynamic reporting size for codebook based on available resources in the uplink phase. More details can be found in clause 5.2.3 of 3GPP TS 38.214.

Also Type-II codebook is based on aperiodic CSI reporting, and only reported in PUSCH via downlink control information (DCI) triggering (one exception). Type-I codebook can be based on periodic CSI reporting (physical uplink control channel (PUCCH)) or semi-persistent CSI reporting (physical uplink shared channel (PUSCH) or PUCCH) or aperiodic reporting (PUSCH).

For priority reporting for CSI report Part 2 multiple CSI reports may be transmitted with different priorities, as shown in Table:

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Note that the priority of the N_{Rep} CSI reports can be based on the following:
1. A CSI report corresponding to one CSI reporting configuration for one cell may have higher priority compared with another CSI report corresponding to one other CSI reporting configuration for the same cell.
2. CSI reports intended to one cell may have higher priority compared with other CSI reports intended to another cell.
3. CSI reports may have higher priority based on the CSI report content, e.g., CSI reports carrying L1-RSRP information have higher priority.
4. CSI reports may have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower IDs have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

For triggering aperiodic CSI reporting on PUSCH, a UE needs to report the needed CSI information for the network using the CSI framework in NR Release 15. The triggering mechanism between a report setting and a resource setting can be summarized in Table 2 below.

TABLE 2
Triggering mechanism between a report
setting and a resource setting

| | | Periodic CSI | SP CSI | AP CSI |
|---|---|---|---|---|
| | | reporting | reporting | Reporting |
| Time | Periodic | RRC | MAC CE | DCI |
| Domain | CSI-RS | configured | (PUCCH) | |
| Behaviour of | | | DCI (PUSCH) | |
| Resource | SP CSI-RS | Not Supported | MAC CE | DCI |
| Setting | | | (PUCCH) | |
| | | | DCI (PUSCH) | |
| | AP CSI-RS | Not Supported | Not Supported | DCI |

Moreover,
All associated Resource Settings for a CSI Report Setting need to have same time domain behaviour.
Periodic CSI-RS/IM resource and CSI reports are considered to be present and active once configured by RRC.
Aperiodic and semi-persistent CSI-RS/IM resources and CSI reports needs to be explicitly triggered or activated.
Aperiodic CSI-RS/IM resources and aperiodic CSI reports, the triggering is done jointly by transmitting a DCI Format 0-1.
Semi-persistent CSI-RS/IM resources and semi-persistent CSI reports are independently activated.

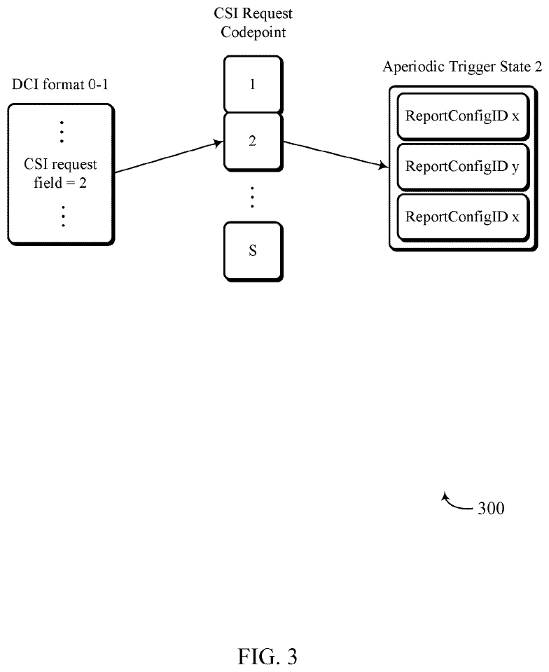

FIG. 3 illustrates an aperiodic trigger state 300 defining a list of CSI report settings. For instance, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC, such as illustrated in FIG. 2. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

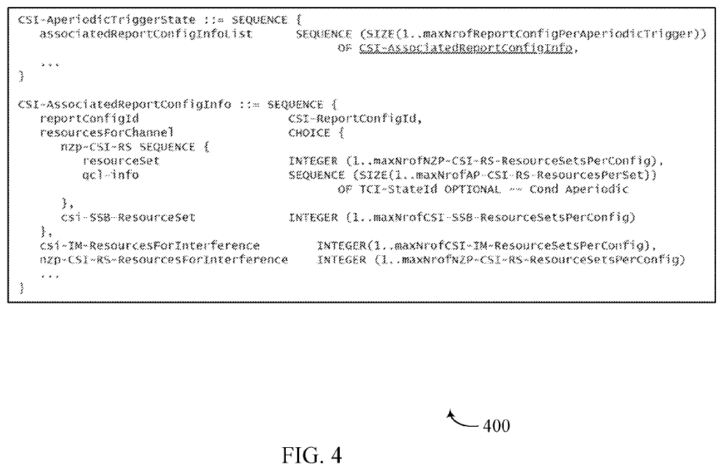

FIG. 4 illustrates an information element 400 for pertaining to CSI reporting. For instance, when the CSI Report Setting is linked with aperiodic Resource Setting (e.g., including multiple Resource Sets), the aperiodic NZP CSI-RS Resource Set for channel measurement, the aperiodic CSI-TM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE considers that the resources used for the computation of the channel and interference can be processed with the same spatial filter e.g. quasi-co-located with respect to “QCL-TypeD.”

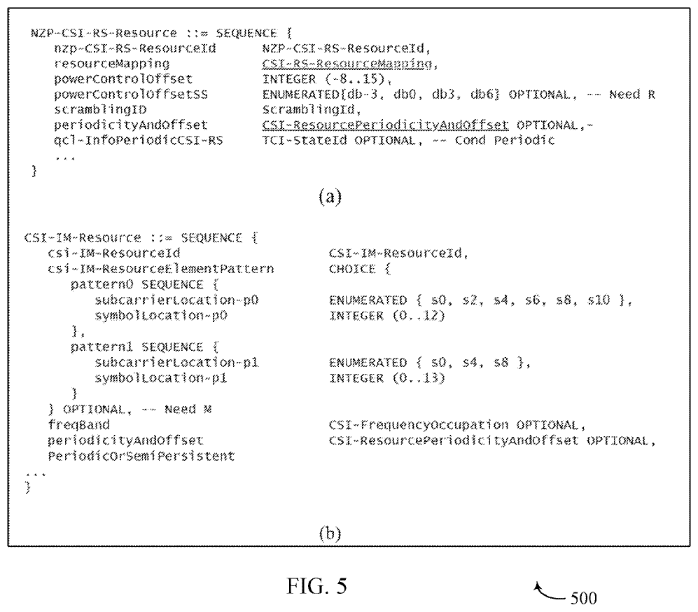

FIG. 5 illustrates an information element 500 for RRC configuration for NZP-CSI-RS/CSI-IM resources. The information element 400, for instance, illustrates RRC configuration (a) for NZP-CSI-RS Resource and (b) for CSI-IM-Resource.

Table 3 presents types of uplink channels used for CSI reporting as a function of the CSI codebook type.

TABLE 3
Uplink channels used for CSI reporting
as a function of the CSI codebook type

| | Periodic CSI | SP CSI | AP CSI |
|---|---|---|---|
| | reporting | reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case uplink control information (UCI) payload size design would result in large overhead.

CSI Part 1 has a fixed payload size (and can be decoded by the gNB without prior information) and contains the following:
RI (if reported), CRI (if reported) and CQI for the first codeword,
number of non-zero wideband amplitude coefficients per layer for Type II CSI feedback on PUSCH.

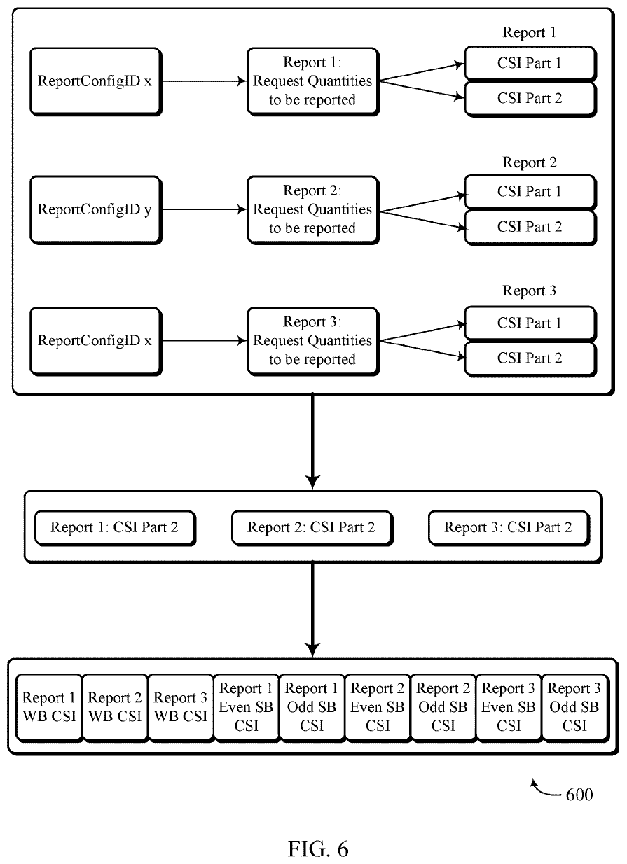

FIG. 6 illustrates a scenario 600 for partial CSI omission for PUSCH-Based CSI. The scenario 600, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 can be ordered as illustrated in the scenario 600.

As mentioned above, CSI reports are prioritized according to:
1. time-domain behavior and physical channel, where more dynamic reports are given precedence over less dynamic reports and PUSCH has precedence over PUCCH.
2. CSI content, where beam reports (e.g. L1-RSRP reporting) has priority over regular CSI reports.
3. the serving cell to which the CSI corresponds (in case of CA operation). CSI corresponding to the PCell has priority over CSI corresponding to Scells.
4. the reportConfigID.

Some proposals pertaining to wireless communications systems discuss using deep learning methods to efficiently compress and send CSI information to the gNB. For instance, one proposal suggests using a multilayer neural network to compress the input CSI and then instead of the original CSI, send the compressed information. Further, this proposal can be enhanced using a multiresolution encoder/decoder and which can reduce the Mean Square Error (MSE) between a desired and generated output.

Another proposal presents a scheme where the compressed continuous representation is first quantized and then transmitted to the gNB side. In a related proposal, a vector quantization scheme is presented using neural networks where the prior is learnt from the data rather than being static. This proposal, for instance, has been used for compressed transmission of images.

One way to train such machine learning models for CSI information is to select a UE from an environment (e.g., Uₖ with reference to system 200) and collect training data associated to the selected UE. The network structure, hyperparameters of the model, codebook values, and neural network weights can be determined based on the collected data. After training a model, the parameters related to each part, e.g., the UE and the network entity portions, can be transmitted to a corresponding node if not already available at that node. For example, if the model is trained at a network entity, the information regarding the weights of the different model components, the quantization codebook, and/or the number of quantization levels can be transferred to the UE using appropriate signaling schemes.

Such a trained model may exhibit acceptable performance for Uₖ as data collected from the user Uₖ is used for training. The trained model, however, might have less optimal performance for other UEs such as if some of the statistics of the channel at a new node (e.g., U_{J}) are different from Uₖ. Further, the structure of the model might need to be changed if a network parameter changes. For instance, a number of bits that can be used in the feedback can be different for U_{J} and Uₖ resulting in a different determination and/or selection of the values of Q and J. This scheme, however, may involve multiple models (e.g., one for each particular UE) which can be complex to store, manage, and assign to a new UEs.

An alternative is to combine the training data of a set of UEs and construct a single model for the entire set of UEs. Such a model, however, may have inferior performance as there might be users which have significant difference in UE channel statistics. Thus, training a single model with inputs having different statistics may result in a model with average and sub-optimal performance over different UE types.

Accordingly, solutions are described in this disclosure for different CSI feedback mechanisms that provide CSI feedback based on AI models. For instance, this disclosure presents details corresponding to signaling of training data, parameters of AI models, and CSI feedback based on such models. To reduce an amount of CSI feedback, implementations construct a latent representation of H, e.g., a low order latent representation. Implementations described herein, for example, use data-driven approaches to determine a correlation between the entries of H to reduce the amount of CSI feedback.

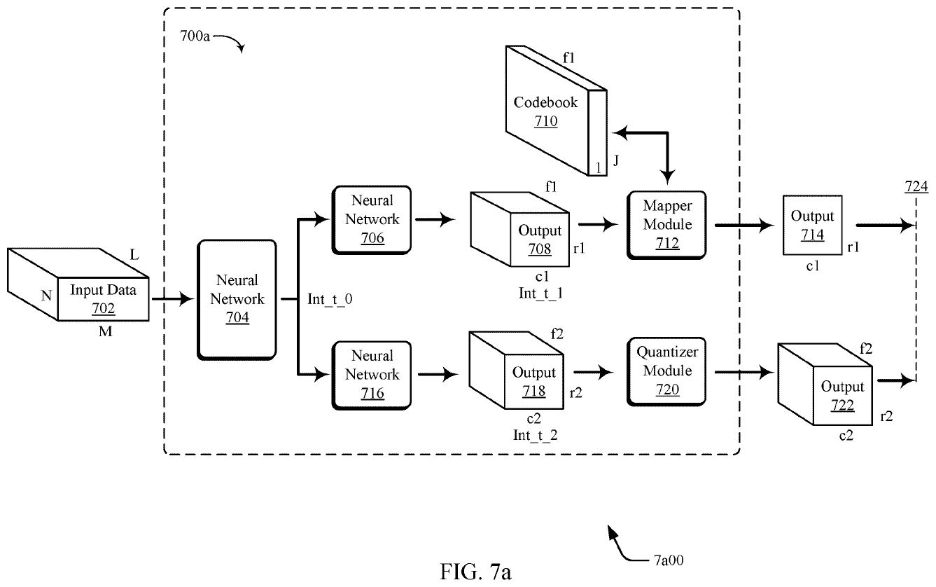

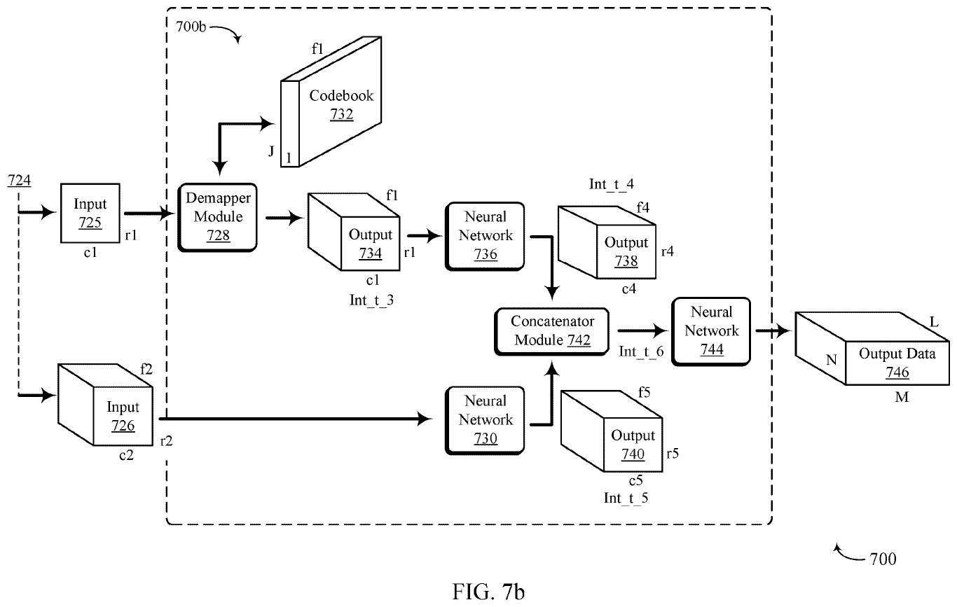

FIGS. 7a, 7b illustrate respectively a UE subsystem 700a and a network subsystem 700b of a CSI system 700 that supports generating a measurement report using one of multiple available artificial intelligence models in accordance with aspects of the present disclosure. In at least one implementation the network subsystem 700b is implemented at a network entity 102. As further detailed below, the CSI system 700 includes two branches, a scalar quantization branch (e.g., the lower branch) and a quantization using codebook branch, e.g., the upper branch.

According to one or more implementations, two latent representations of input data are generated. In at least one example, the input data is the channel matrix H and/or based on the channel matrix such as a function of the channel matrix, e.g., channel covariance matrix, eigen decomposition such as at least one eigen vectors, singular value decomposition (SVD) such as the at least one vector of the left and/or right singular vectors, etc. According to implementations the latent representations contain “real” numbers and thus it may not be practicable to send the latent representations directly using a finite number of feedback bits.

Accordingly, at the lower branch (e.g., scalar quantization branch), the UE subsystem 700a quantizes real values of a latent representation and sends the quantized version to the network subsystem 700b, e.g., network entity such as gNB. In at least one example, the quantization occurring in the lower branch is based on a linear quantization with Q levels. At the upper branch (e.g., the quantization using codebook branch) the UE subsystem 700a compares the latent representation against codewords of a codebook and then instead of sending the actual latent representation, the UE subsystem 700a can transmit the ID(s) and/or index(s) of at least one codeword based on a measure of correlation or similarity of the indicated codeword(s) and the actual latent representation, such as the closest codeword(s), a weighted combination of a subset of the codewords, etc. Note that the codewords of the codebook are not fixed and can be learned during a training phase.

Additionally, the various blocks of the network subsystem 700b can be trained to use the bits received from the UE subsystem 700a (e.g., feedback CSI bits such as those corresponding to the two latent representations) to generate a desired output. In at least some examples, a training objective is to have the output data (e.g., reconstructed data) as similar as possible to the input data. Alternatively or additionally other objective functions (e.g., loss functions) may be used for training as well.

In the CSI system 700 different blocks of the system and associated procedures for the feedback CSI data can be generated at the UE subsystem 700a (e.g., a transmitter node) and then used by the network subsystem 700b (e.g., a receiver node) for reconstruction of the input data. Different aspects and operations of the system 700 are now described.

In the UE subsystem 700a, input data 702 is input to a neural network 704. One example of the input data 702 is the H matrix that defined above. In implementations the input data 702 is a three-dimensional matrix representing a channel between Tx-Rx antenna pairs (N×M) over frequency bands, L, for a UE. In at least some examples, the frequency bands may represent the channel per subcarrier, per every x subcarriers, per subcarrier group such as a PRB or sub-PRB or RBG (resource block group), etc. Further, the input data 702 can be a function of the H matrix, e.g., a vector corresponding to a singular vector that is associated with a largest singular value of the matrix H.

The neural network 704 can be implemented as a multilayer neural network, for example using a convolutional neural network (CNN). In implementations the neural network 704 can be shared between both upper and lower branches of the UE subsystem 700a. The intermediate tensor output of neural network 704 (“Int_t_0”) may be of size c0× r0× f0. A neural network 706 (e.g., a multilayer neural network such as a CNN) receives output from the neural network 704 and generates output 708. The output 708, for instance, is a 3D intermediate tensor of size c1×r1×fi (namely “Int_t_1”), where f1 represents, e.g., a number of filters at the last convolutional layer of the neural network 706 using CNN.

In at least some implementations for each input sample (and based on the neural network 706 weights), there will be c1×r1 tensors of size 1×f1 at the output 708. Parameters c1, r1, and f1, for instance, are the hyperparameters that are determined during the training phase.

According to one or more implementations the UE subsystem 700a sends a representation of the output 708 to the network subsystem 700b using a quantization codebook 710. The quantization codebook 710, for instance, is composed of J tensors (codewords) of size 1×f1. Each of these tensors have an ID or index which can be represented using log₂ J bits, e.g., since there are J different codewords.

Further to the UE subsystem 700a, a mapper module 712 receives the output 708 and for each of its c1×r1 tensors, the mapper module 712 generates at least one ID (between 0 to J) which shows the ID of the codeword (from the quantization codebook 710) which has a closest and/or largest correlation to the output 708. For instance, for the output 708, the mapper module 712 maps the input tensor of c1×r1×fi to c1×r1 IDs each can be represented using log₂ J bits to generate an output 714. Different metrics (e.g., Euclidian distance) can be used to compute the closeness between the vectors of the output 708 and the codebook 710 to generate the output 714.

The UE subsystem 700a further includes a neural network 716 which can be implemented as a multilayer neural network, e.g., using CNN. The neural network 716 receives the output from the neural network 704 (e.g., the intermediate tensor output “Int_t_0”) and generates an output 718. The output 718, for instance, represents a 3D intermediate tensor of size c2×r2×f2 (namely “Int_t_2”), where f2 is, e.g., a number of filters at a last convolutional layer of the neural network 716 realized using CNN. Further, the parameters c2, r2, and f2 are the hyperparameters that are determined during the training phase. The output 718 is not necessarily of 3D shape and may optionally be 1D or 2D tensors such as depending on the structure of the neural network 716.

To enable the UE subsystem 700a to send the output 718 and/or some representation thereof to the network subsystem 700b and to reduce the communication overhead, it may first pass the output 718 through a quantizer module 720, which in at least some implementations represents a scalar quantizer. In at least one example, the quantizer module 720 quantizes each value of the output 718 into 2^{Q} levels, e.g., each quantized value can be represented using Q bits. The value of Q and the type of quantization used by the quantizer module 720 can be determined during the training phase. Thus, the quantizer module 720 receives the output 718 as input, and the quantizer module 720 generates an output 722. The output 722, for instance, represents a tensor of size c2×r2×f2 where each entry takes only one of the 2^{Q} possible values.

Accordingly, the UE subsystem 700a transmits a representation of the outputs 714, 722 (e.g., encoded representations of the outputs 714, 722) to the network subsystem 700b via a feedback link 724. The outputs 714, 722 and/or representations thereof are sent (e.g., with a source and/or channel code and a modulation) to the network subsystem 700b e.g., with the feedback CSI information bits.

According to implementations, the outputs 714, 722 can be sent to the network subsystem 700b using c1×r1× log₂ J+c2×r2×f2× Q bits (information bits). For instance, (c1, r1) are the number of latent vectors at the upper branch, J is the number of codewords in the quantization codebook 710 at the upper branch, (c2, r2, f2) show the size of the latent representation in lower branch, and Q is the number of level used in the scalar quantizer in the lower branch.

At the network subsystem 700b the gNB side receives via the feedback link 724 an input 725 and an input 726 which represent the output 714 and the output 722, respectively. The network subsystem 700b feeds the input 725 to a demapper module 728 (e.g., in the upper branch) and the input 726 to a neural network 730, e.g., in the lower branch. The demapper module 728 takes as input the received the c1×r1 “IDs” in the input 725 and replaces and/or maps them to the corresponding codeword of size 1×f1 from a quantization codebook 732 which includes J tensors (codewords) of size 1×f1. The demapper module 728 outputs an output 734, which in at least one implementation represents a 3D tensor of size c1×r1×f1, e.g., “Intt 3”. The quantization codebook 732 may be same or different than the quantization codebook 710 of the UE subsystem 700a.

The network subsystem 700b further includes a neural network 736 which can be implemented as a multilayer neural network, e.g., using CNN. The neural network 736 takes the output 734 as input and generates an output 738 (“Int_t 4”). The output 738, for instance, is a 3D tensor of size c4×r4×f4. Further, parameters c4, r4, and f4 are the hyperparameters that are determined during the training phase.

As mentioned above the neural network 730 takes the input 726 as input. Accordingly, the neural network 730 generates an output 740 (“Int_t 5”). The output 740, for instance, is a 3D tensor of size c5×r5×f5. Parameters c5, r5, and f5 are the hyperparameters that are determined during the training phase. In one example, c4=c5, and r4=r5.

To assist in concatenation of the outputs 738, 740, parameters c5 and r5 may be equal to c4 and r4, respectively. Considering these design parameters, c_{g} and r_{g} can be used as the first two dimensions of outputs 738, 740, e.g., output 738 can have the size of c_{g}×r_{g}×f4 and output 740 can have the size c_{g}×r_{g}×f5. Accordingly, a concatenator module 742 concatenates the outputs 738, 740 along the third dimension (e.g., filter dimension) and constructs “Int t 6”. Thus, “Int_t_6” can be a 3D tensor of size c_{g}×r_{g}×(f4+f5).

The network subsystem 700b further includes a neural network 744. The neural network 744, for instance, is a multilayer neural network, such as implemented using CNN. The neural network 744 takes “Int_t_6” (output of the concatenator module 742) as input and generates output data 746. The output data 746, for example, represents a reconstructed data representation of the input data 702 previously input to the UE subsystem 700a. The output data 746 can be shared between both upper and lower branches of the network subsystem 700b. In at least some implementations, to enable reconstruction of the original input data 702, the size of the output data 746 is N×M×L.

The following section presents implementation details for the system 700. In this section, “UE” can refer to the UE subsystem 700a and “network,” “network entity,” and/or “gNB” can refer to the network subsystem 700b.

Considerations regarding the network structure:
a. In one example, the output of the neural network 716 is designed to be in the range [−1,1]. For example, this can be enabled by applying an appropriate activation function (e.g., “tanh”) for the last layer of the neural network 716.
b. Assuming an ideal feedback channel, input 725 and input 726 may be equal to output 714 and output 722, respectively. They could be different in cases of a non-ideal feedback channel, e.g., some elements of inputs 725, 726 are received with errors, omission of some elements of outputs 714, 722 in the feedback CSI, etc. Such effects may be modelled appropriately in the network structure of the system 700.
c. The neural network structure of the different neural networks of the system 700 can be hyperparameters and can be determined during the training phase. Note that they can be fixed during the inference phase.
d. The total available feedback rates can be partitioned between the data used for transmission of output 714 and output 722. For instance, on the selection of (c1, r1), (c2, r2), the number of codewords in the quantization codebook 710, e.g., J, and the levels of scalar quantization, e.g., Q.
e. The system 700 can be scaled down to:
   Use codebook-based quantization branch only: For this case, the lower branch of the UE subsystem 700a can be turned off or not used. In addition, neural network 730 and the concatenator module 742 can be removed from the network subsystem 700b.
   Use scalar quantization branch only: For this case the upper branch of the UE subsystem 700a can be turned off or not used. In addition, the demapper module 728, the neural network 736, and the concatenator module 742 can be removed from the network subsystem 700b. The codebook 732 may optionally not be implemented and/or utilized.
   In some examples, the network subsystem 700b (e.g., gNB) may indicate to the UE subsystem 700a (e.g., UE) to use at least one of the codebook-based quantization branch only, scalar quantization branch only, or both codebook-based quantization branch and scalar quantization branch.
   In some examples, the UE subsystem 700a may determine to feedback the output of at least one of the codebook-based quantization branch only, scalar quantization branch only, or both codebook-based quantization branch and scalar quantization branch. Such determination may be based on the input data 702, e.g., channel matrix H. The UE subsystem 700a may indicate to the network subsystem 700b an indication of such determination, e.g., the feedback CSI is based on codebook-based quantization branch only, scalar quantization branch only, or both codebook-based quantization branch and scalar quantization branch.
f A similar framework can be used when the input data 702 is not directly equal to the matrix H. The input data 702, alternatively, could be an input data represented as a 3D matrix, e.g., a DFT transformed version of the channel matrix or a matrix representing the one/several eigen vectors and/or eigen value(s) of the channel matrix in different frequency bands. Alternatively or additionally, the input data 702 may correspond to a set of at least one precoding vector that is associated with a downlink transmission from a network node to the UE. As some other examples, H could be of size N×M×T where the third dimension represents values at different time symbols and/or time slots or could of size N×M×Z where the third dimension represents a composite time/frequency domain e.g., a stacked or concatenated frequency and time-domain vectors.
g. The entries of H can be complex numbers and since most of the neural network methods work with real numbers, a transformation can be employed from a complex domain to the real domain. For example, the real and imaginary parts of the input data 702 (of size N×M×L) can be separated and then concatenated together to generate an input data of size 2N×M×L which only has real values. The concatenation can happen in other dimensions as well. In another example, the system 700 may virtually extend the channel matrix with their conjugate and then use inverse fast Fourier transform (IFFT) to transform the extended data. The results, for instance, will be real numbers and can be used with neural networks.
h. Some of the tensors may have a reduced dimensionality. For instance, the second and/or third dimension 3D tensors described above may have value 1 reducing to 1D or 2D tensors.

Considerations regarding the training and/or inference phases:
a. The input data 702 can be collected at the UE subsystem 700a and then depending on where the model will be trained, it can be used at the UE subsystem 700a or transferred to the network subsystem 700b.
b. The neural network weights are initialized randomly for training. The neural network weights can be changed during the training phase in a way that reduces the loss function. The neural network weights can be fixed during the inference time.
c. The tensors of the quantization codebooks may not be fixed and they can be determined during the training procedure. They can also be fixed during the inference phase.
d. It can be considered that the network subsystem 700b quantization codebook 732 is the same as the UE subsystem 700a quantization codebook 710. For instance, after the model is trained, there may be one quantization codebook which will be used by both subsystem 700a and subsystem 700b. For example, assuming that the complete model has been trained at the network subsystem 700b, the resulted quantization codebook can be transferred to the UE subsystem 700a along the other weights of the neural network blocks that are used for the UE subsystem 700a. If the training phase happens at the UE subsystem 700a, the quantization codebook 710 and the weights of the network subsystem 700b blocks will be transferred to the network subsystem 700b.

Considerations regarding the network loss function:
a. One example of the objective function is to minimize the mean square error between the input data 702 and the output data 746 (reconstructed data).
b. One method to have an end-to-end differentiable loss function is to consider that input 725 is equal to the output 708 and input 726 is equal to output 718 in the backpropagation phase.

Considerations regarding communication requirements:
a. If the model trained at the network subsystem 700b, some mechanisms for exchange of some information between the UE subsystem 700a and the network subsystem 700b can be provided.
   A method to send input data (e.g., channel measurements (or any of its desired transformation)) to the network subsystem 700b
   A method to send the final neural network weights of the UE subsystem 700a side to the UE subsystem 700a
   A method to send a quantization codebook (e.g., learned codebook) to the UE subsystem 700a
   A method to send the number of quantization levels, Q, of the quantizer module 720 to the UE subsystem 700a
   A method to transmit output 714 and output 722 (and/or representations thereof) to the network subsystem 700b
b. If the model is trained at the UE subsystem 700a, some mechanisms can be provided for exchange of some information between the UE subsystem 700a and the network subsystem 700b.
   A method to send the final neural network weights of the network subsystem 700b side to the network subsystem 700b.
   A method to send a quantization codebook (e.g., learned codebook) to the network subsystem 700b.
   A method to transmit output 714 and output 722 (and/or representations thereof) to the network subsystem 700b.

It should be noted that in at least some implementations the UE subsystem 700a is to have enough computational resources to perform the training. Further, the UE subsystem 700a may have access to sufficient training samples of an environment to create a model with appropriate generalizations, e.g., in scenarios where the same model is to be used by different UEs. In at least some examples, a UE performing training may be a high-performance UE and/or AI/ML model training source with capabilities for model training (e.g., sufficient computational and/or memory resources) and model transfer to a gNB (e.g., via Uu interface) and/or a UE, e.g., via sidelink channels.

According to one or more implementations, CSI feedback information (also referred to here as H-CSI) can be determined according to a codebook configuration including codebook subset restriction, time-domain behavior (e.g., periodic, semi-persistent, aperiodic), and measurement restriction configurations (e.g., restrictions on which RS symbols and/or slots can be used to determine the input data), e.g., for the upper branch of the system 700.
a. The lower branch of the system 700 may also be independently associated with a different time-domain behavior and/or measurement restriction configuration than that of the upper branch of the system 700.
b. In at least one example, a UE receives a codebook subset parameter or a rank parameter configuration, and a CSI report is tailored for a subset of permitted codewords or ranks. The UE determines if there is a trained neural network model available corresponding to the configured codebook subset/rank parameter. The UE can indicate to the network whether the model is available. A CSI report associated with the parameter can be provided if the corresponding neural network model is available after a time ‘T’ from at least one of (a) a CSI trigger or (b) after reception of the restriction configuration, or (c) after an transmission of an acknowledgment in response to reception of the parameter configuration. The time ‘T’ can depend on the configured parameter (e.g., for each available rank parameter, the network can configure a corresponding ‘T’ value or the UE can report a ‘T’ value via UE capability signaling to the network).

In implementations, an RRC message/DCI/MAC-CE associated with an H-CSI report (e.g., DCI/MAC-CE triggering the H-CSI report) can indicate one or more of whether and which of the parameters corresponding to the lower branch, upper branch, neural network weights, codebook, or a combination thereof are to be signaled. Alternatively or additionally, the UE in the corresponding H-CSI report can indicate such information.

In implementations, an H-CSI report can include one or more subband H-CSI reports and a wideband H-CSI report and:
a. The subband size associated with each subband H-CSI report can be reported by the UE and can be determined based on the neural networks.
b. A subband/wideband H-CSI report can be derived based on the lower branch, upper branch, or the combination of the two branches, and the wideband H-CSI report can be independently configured/indicated to be based on the lower branch/upper branch or the combination of the two branches.
c. In at least some examples, the wideband H-CSI report may be based on input data that has sparser frequency resolution than that used for subband H-CSI report e.g., input data based on a channel value every x PRBs or PRB-Groups, x=4 for wideband H-CSI report and x=1 for subband H-CSI report.

In implementations, the network configures the UE to use only upper branch, only lower branch, or use both branches.

In implementations, a H-CSI report can be provided by the UE (or H-CSI report is valid) if the H matrix is computed (e.g., based on the associated scheduled data) over a number of REs larger than a threshold. Further, a subband H-CSI report can be provided/valid if at least a wideband H-CSI report associated with the subband H-CSI report is computed over a larger than a threshold number of resource elements (RE).

In implementations, the parameters that can be signaled include at least one of. (i) an output of a scalar quantization branch (e.g., sent in an uplink direction), (ii) an output of a quantization codebook branch (e.g., sent in an uplink direction), (iii) a codebook comprising the codewords corresponding to the quantization codebook branch (e.g., sent in a downlink direction, such as when training occurs at network side), (iv) parameters corresponding to neural network nodes for each of the scalar quantization branch and the quantization codebook branch (e.g., sent in a downlink direction, such as when training occurs at network side), and (v) parameters related to the blocks shared between the two branches of the system 700.

In at least one implementation, the parameters corresponding to the codebook and neural network parameters are computed at the network and signaled to the UE via at least one of:
a. Downlink control information (DCI) signaling with a DCI format that carries information corresponding to CSI configuration;
b. Higher-layer signaling, e.g., MAC-CE signaling or RRC signaling; or
c. Combinations thereof.

In at least one implementation, the parameters corresponding to the codebook and neural network parameters are computed at the UE and signaled to the network via at least one of:
a. A part of a CSI report, where the CSI report comprises at least one part;
b. A part of an AI/ML/neural network-based report; or
c. Combinations thereof.

In at least one implementation, the network configures the UE to report at least one of the quantization codebook and the neural network parameters based on a report quantity included as part of a codebook configuration.

In at least one implementation, the parameters corresponding to the scalar quantization branch are reported in a first CSI report part, where the first CSI report part is prior to a second CSI report part corresponding to the codebook quantization branch and the parameters related to the shared part which are reported subsequently.

In at least one implementation, a UE is instructed to iteratively use the upper branch of the UE subsystem 700a for the first k₁>0 time slots, then use the lower branch of the UE subsystem 700a for the next k₂>0 time slots, and then use a model with both upper and lower branches for subsequent k₃>0 time slots.

In at least one implementation, the output of at least one of the scalar quantization branch and the codebook quantization branch corresponds to PMI, CQI, and/or a combination thereof.

Various implementations described herein provide for training of a two-sided model. For instance, consider that there are K users in the network and H^{k} is a set of training data collected from Uₖ. The term [symbol] can be used to refer to a general two-sided CSI feedback model and [symbol] and [symbol] to refer to the encoder (e.g., UE part) and decoder part (e.g., gNB part) of the model, respectively.

According to one or more implementations, separate models can be used for different user types and/or different network requirements. For instance, consider that the K users can be grouped into G types (G≤K), T_{g}, g={1, . . . , G}, where the users in each type have similar statistics for their H^{k}. With this assumption, we can combine training data of users of one type and construct the training data for that type, e.g.,

$$H [ g ] = \{ ⋃ {H}^{k} , ∀ k \vert {U}_{k} ∈ {T}_{g} \} .$$

In such implementations, instead of a single model, there can be up to G different versions of M (for example one for each type), where model M[g], g={1,2, . . . , G} has been trained using the H[g]training dataset. Since users of each type may have similar statistics and the model can be trained using the same type of data, the performance of model M[g]can be suitable for UEs of type g.

Other than the user type, M can be changed if other parameters of the network change. One important network parameter is the number of feedback bits. With reference to the system 700 introduced above, a change of a number of feedback bits may result in change in values of J, Q and may also change the structure of the neural network blocks, e.g., values of c₁, r₁, f₁, c₂, r₂, f₂. Similar to scenarios for different user types, to accommodate different scenarios, an example implementation is to train and save different [symbol] for different requirements, e.g., different numbers of feedback bits.

For implementations involving multiple models, implementations can be provided to store different models and select and/or use an appropriate model based on the type of the UE, e.g., when a UE connects to a network and/or is configured for CSI feedback based on a two-sided model. For example, different models can be stored at a network entity. Accordingly, when a new UE connects to the network and/or is configured for CSI feedback based on two-sided model, the network entity can decide which model is to be used for that UE. For instance, channel measurements can be collected from that UE and checked against different models to see which model is a best fit for the UE. The network entity can then send the UE one or more portions of the model, e.g., [symbol] [g]for the UE, such as based on the system 700, which may include transmission of a quantization codebook and quantization level. In at least some implementations, a model selection neural network may be used to select a model for CSI feedback based on UE channel measurements and/or a representation thereof. For example, the model selection neural network may be transmitted to the UE and the model selection procedure is performed at the UE. Alternatively or additionally, the model selection procedure is performed at the network entity and/or another network node based on UE channel measurement feedback from the UE.

In at least some implementations, different models can be preloaded (e.g., via higher layer signaling or configuration such as RRC) to a UE and a network entity informs the UE which model (e.g., via a model index) is to be used. Such implementations can reduce signaling when a model switch is implemented. Further, model parameters can be transferred to the UE beforehand, such as when the UE wakes-up, connects, is configured for CSI feedback based on model(s), and/or in conjunction with manufacture and/or initial configuration and deployment of the UE.

In at least some implementations where UEs of an environment have similar H statistics, a network entity may have a single model available. Based on changes in the UEs and/or environment, the network entity can decide that a current model is not a good fit. In such scenarios, an update procedure can be started to retrain the model. The retraining may be performed at a UE, network entity, and/or other node. Parameters of the updated/retrained model can subsequently be sent to a corresponding network entity and UE, such as if not already available at that node. Such implementations can reduce the need to train and save multiple models and also may avoid a model selection procedure.

In at least some implementations as part of a model update procedure, initial weights of the model may be random numbers (e.g., based on a uniform or gaussian distribution), weights of the current model, weights of a model trained using a meta learning scheme, etc. The weights of the meta learning scheme, for instance, can be determined by training the model using a meta learning approach such as model-agnostic meta-learning (MAML) and using the data collected using multiple user types.

According to implementations, the discussion above can be applied when G=1 and/or for a single set of network requirements. Further, if there are multiple UE types and multiple network requirements, multiple models can be constructed based on both UE type and network requirement.

Implementations described in this disclosure also enable a single model for different numbers of feedback bits. For instance, implementations enable training, deployment, and operation of two sided models when a number of feedback bits is not constant. For simplicity of explanation, consider that there may be one user type. However, for multiple user type scenarios, the described approaches can be combined with implementations described above.

For example, considering the system 700, an amount of information that a UE (e.g., the UE subsystem 700a) sends to a network entity (e.g., the network subsystem 700b, e.g., gNB) can be based on one or more of a) size of the latent representation that can be quantized using the quantizer module 720 (e.g. the output 718), b) a number of bits used for quantizing each value (e.g., log₂(Q) of the quantizer module 720), c) a number of vectors that will be quantized using the quantization codebook 710 (e.g. the output 714), d) the number of bits used to select a quantization codebook codeword, e.g., log₂(J) of the mapper module 712. For instance, in the current example, a total number of bits that can be sent to the network subsystem 700b can be r₁×c₁× log₂(J)+r₂×c₂×f₂× log₂(Q).

To enable different numbers of feedback bits to be supported, the system 700 described above can be utilized and based on a number of feedback bits, create different models by adjusting r₁, c₁,J, r₂, c₂, f2, and Q and alternatively or additionally, the neural networks 704, 706, 716.

In at least some implementations that utilize a single model and support multiple feedback rates, r₁, c₁, J, r₂, c₂, and f₂ can be fixed the quantization levels changed, e.g., Q. Considering this, a network can be implemented which uses [symbol] r₁×cᵢ× log₂(J)+r₂×c₂×f₂× [symbol] bits where [symbol] is an integer number, [symbol] ={0,1,} and [symbol] represents the number of bits used for sending each value after value quantization. The value of [symbol] may be configured, provided, and/or indicated to a UE such as via CSI report configuration, RRC, MAC-CE, DCI (e.g., for semi-persistent and/or aperiodic CSI reporting), etc. Further, the value of [symbol] may be selected, reported, and/or determined by the UE based on a number of resources for CSI feedback, such as a number of REs and/or a coding rate, where a CSI report code rate is less or equal to a threshold (e.g., configured by the higher layers), maximum CSI UCI information bits and/or payload size, etc. In implementations where the value of l selected and/or reported by the UE, l may be included in the Part 1 of a CSI report for a CSI report comprising multiple (e.g., two) parts.

Various implementations enable training, selection, and operation of models separately for each l. Further, if a model is changed only using l, the models can have a property where the structure of the neural networks (e.g., of the system 700) can remain the same between models corresponding to different feedback rates. Therefore, a single [symbol] can be utilized (e.g., corresponding to a fixed neural network structure and quantization codebook) and the two-sided model can be trained such that it supports different values of l. For instance, a same training data set can be applied with the value of l changing from one sample to another during the training phase. Using [symbol] such implementations, the neural networks in the [symbol] and [symbol] can be trained even though a quantization level might change from time to time. In at least some implementations the network entity can implement the [symbol] part and [symbol] can be implemented by the UEs.

Such implementations may reduce or eliminate the need to update the [symbol] or [symbol] after each change in the number of feedback bits and a network entity may notify a UE of a new Q and other weights of the neural network blocks can remain same, e.g., unchanged. This may reduce signaling overhead and latency due to model selection.

In at least some implementations, different values of e can be provided to support different feedback rates by rounding, truncating, and/or dropping one or more least significant bits (LSB) of a reference Q-level quantizer of the latent representation, e.g., on the lower branch of the system 700. Further, in at least some implementations, the upper branch of the system 700 may be not present, and the system 700 utilizes the scalar quantization.

In at least some implementations, the neural networks of the system 700 can be represented as respective blocks and at least one block can be further decomposed into a plurality sub-blocks. In one example, the neural network 716 is decomposed into blocks B₃₁, B₃₂, . . . , B_{3K} and neural network 730 is decomposed into B₅₁, B₅₂, . . . , B_{5K}, such that sub-block B₃ₖ can be coupled with sub-block B₅ₖ. In such implementations, a first of two models may comprise a first subset of sub-blocks, e.g., B₃₁, B₃₃ under neural network 716, B₅₁, B₅₃ under neural network 730, and a second of the two models comprises a second subset of sub-blocks, e.g., B₃₁, B₃₂ under neural network 716, and B₅₁, B₅₂ under neural network 730.

In at least some implementations, a UE is configured (e.g., using an associated neural network model configuration) with a plurality of feedback rates and/or quantization granularities corresponding to a neural network. In at least one example, a minimum number of bits and a maximum number of bits is configured, and the range in between (with potential skipping) is supported.

In at least some implementations, a UE determines a feedback rate based on a corresponding CSI report configuration, e.g., based on one or more of PUCCH-CSI-Resources in CSI-ReportConfig. The UE may not be configured with a list of PUCCH resources in the corresponding CSI report configuration that is not associated with and/or cannot accommodate the configured feedback rates. In an alternative or additional implementation, the UE is configured with a particular feedback rate (e.g., in the corresponding CSI report configuration), and determines a PUCCH resource from a list of PUCCH resources to convey the CSI report based on the CSI report payload size.

In at least some implementations, a UE indicates a feedback rate used along with the CSI report, or the network entity infers the feedback rate based on the PUCCH resource carrying the CSI report. In the latter case, another CSI report (e.g., L1-RSRP or RI) may be indicated to not to be multiplexed with the CSI report corresponding to latent representation of the channel.

In at least some implementations, a UE may not be configured to provide an aperiodic CSI report sooner than:
a 1^{st} specified time from a DCI triggering a CSI report for a 1^{st} feedback rate, and
a 2^{nd} specified time from a DCI triggering CSI report for a 2^{nd} feedback rate.

In at least some implementations, if a feedback payload part of a quantized representation of a latent representation (r_{z}×c₂×f₂× [symbol] ) with a first determined ‘1’ value (e.g., '1 is ′RRC/MAC-CE/DCI indicated or determined according to a CSI report configuration) corresponds to a first PUCCH resource for transmitting the CSI report that is not available (e.g., due to collision of the PUCCH with a downlink symbol):
The UE (e.g., if configured and/or indicated, and/or has sufficient time) provides the feedback payload based on a second determined ‘l’ value,
   wherein the second ‘l’ value is smaller than the first ‘l’ value if a second PUCCH resource is available that can carry the feedback payload.
      Wherein the availability is conditioned on satisfying some timelines,
         e.g., not earlier than a first threshold or not later than a second threshold, wherein the thresholds are defined with respect to and/or relative to a DCI triggering the CSI report (e.g., a last symbol of the DCI) and/or with respect to the first PUCCH resource, e.g., a first symbol of the first PUCCH resource.

Implementations described herein also provide solutions to address CSI report collision. For instance, if two CSI reports collide when a UE is configured to transmit two colliding CSI reports, the UE based on indication and/or configuration can change a quantization rate (‘1’) of one of the reports and transmit both reports instead of dropping one of the two reports. For instance, a 1^{st} CSI report is associated with a quantized representation of one latent representation, and a 2^{nd} CSI report is associated with one or more of Channel Quality Indicator (CQI), PMI, CSI-RS resource indicator (CRI), synchronization signal (SS)/physical broadcast channel (PBCH) Block Resource indicator (SSBRI), layer indicator (LI), rank indicator (RI), L1-RSRP, L1-SINR or Capability[Set] Index. Thus, the UE can lower ‘1’ for the 1” report and send both 1′ and 2^{nd} CSI reports.

In at least some implementations a two-sided model is provided with flexible UE portions. For instance, as discussed above, multiple models can be provided for each group and/or type of UEs, and/or for each network parameter. To improve the performance of such implementations, the following discussion presents an approach to enable fine tuning of models for each UE without undue complexity. For instance, a network entity uses a same [symbol] for UEs of a same category (e.g., with a single set of model properties) and the UEs are flexibly able to use different encoding schemes, which may increase performance. For simplicity of explanation in the following discussion, consider that the network requirements (e.g., number of allowed feedback bits) are fixed. However, if a number of allowed feedback bits are dynamic (e.g., changing), the following implementations can be combined with implementations described above.

Thus, according to at least some implementations that enable flexible UE portions:
1— Consider that a pretrained two-sided model (e.g., [symbol] and M_{d}) is already selected (e.g., if more than one pretrained two-sided model exist) for a particular UE.
2— The decoding part of the model, M_{d}, is then deployed at the network entity, e.g., it can be transmitted to the network entity if training happens at a different node. The encoding part of the model, e.g., Mₑ, is transferred to the UE by the network entity and/or other network node.
3— In at least some implementations, a network node (e.g., gNB) can send M_{d} to the UE.
4— The UE can use the Mₑ to construct the feedback bits based on input channel data. Further, a user can be enabled to fine tune Mₑ.
5— For fine tuning the user, e.g., Uⱼ can use Mₑ and M_{d} to construct a version of the complete model locally. Uⱼ can also collect channel samples as local training data Ĥ^{j}. In at least some implementations, the UE can use a part of the original training data which has similar statistics to its channel condition.
6— U₁ then trains the local model using Ĥ^{j}. In at least one implementation as part of U_{J} training the local model using Ĥ^{j}, Uⱼ is not permitted to change a parameter of the M_{d}, e.g., weights and/or quantization codebook of Ma are fixed. The fine-tuned parameters of the encoding part (e.g., Mₑ) at user j can be denoted by

$${\hat{ℳ}}_{e}^{j} .$$

7— After completion of the training step, Uⱼ can deploy and use

$${\hat{ℳ}}_{e}^{j}$$

(e.g., as fined tuned for Uⱼ) as a UE part of the model, e.g., the UE subsystem 700a.

Note that in at least some implementations, each UE has its own encoding neural network while a network entity may have a single decoding neural network [symbol] . Thus, the existence of several models and performance of model selection may be avoided where each UE adapts the encoding part locally.

Note that in at least some implementations, a UE may change some parts of [symbol] as well during fine tuning. In such implementations, the UE can feedback the updated parts of [symbol] to a network entity.

In at least some implementations, such as when a UE does not have sufficient computational capability for training, the UE can send fil to a training node (e.g., a network entity and/or other node) and training can be performed at the training node. The training node, for example, can use training data which has similar statistics to its channel condition. This information can be transferred to the training node if it is not already available. After completion of the training phase, the updated [symbol] can be sent from the training node to the UE.

In at least some implementations, a UE may also train a local model considering that it can also modify the quantization codebook. In such scenarios, after completion of training, the UE may send the modified quantization codebook to a network entity while other parts of [symbol] may remain fixed. Each UE, for instance, has its own encoder

$${\hat{ℳ}}_{e}^{j} ,$$

and network entities can use a same neural network structure for the group of UEs. For instance, the demapper module 728 uses the quantization codebook associated with each UE.

In at least some implementations of such scenarios, a single model at the network entity can be utilized with multiple quantization codebooks. For instance, model selection may be avoided as each UE can use its own

$${\hat{ℳ}}_{e}^{j}$$

and quantization codebook.

Considering that a UE can report an updated quantization codebook to a network entity, at least one of the following may be considered:
updated quantization codebook is in a form of additional codewords to be appended to an original quantization codebook;
The updated quantization codebook is in a form of additional bits appended to each codeword of the original quantization codebook; and/or
The updated quantization codebook is reported in response to a network configuration parameter that configures the UE to report an updated quantization codebook.

In at least some implementations, a single instance of the upper branch or the lower branch of the system 700 might be not present, and a variation on the system 700 may operate using an instance of the vector/codebook quantization or scalar quantization.

In one or more implementations, CSI feedback is based on AI/ML model selection. The AI/MIL model is any of a variety of AI or ML models, such as neural networks as discussed above. Assume a channel between a UE 104 and a network entity 102 with P channel paths (index μ=0, . . . , P−1) that occupies NSB frequency bands (index n=0, . . . , N_{SB}−1), where the network entity (e.g., gNB) is equipped with K antennas (index k=0, . . . , K−1). The channel at a time index δ can then be represented as follows

$${h}_{k , n} ( δ ) = {\sum }_{p = 0}^{P - 1} {g}_{k , p} {e}^{j 2 π n Δ f {τ}_{p} + j 2 π k \frac{{F}_{c} d}{c} sin {θ}_{p} + j 2 π δ \frac{{F}_{c} v}{c} cos {∅}_{p}}$$

where g_{k,p} refers to complex gain of path p at antenna k, Δf refers to PMI Sub-band spacing, τₚ refers to delay of path p, F_{c} refers to carrier Frequency, c refers to speed of light, d refers to antenna spacing at the network entity, θₚ refers to angular spatial displacement at the network entity antenna array corresponding to path p, δ refers to time index, v refers to relative speed between the network entity and the UE, and φₚ, refers to angle between the moving direction & the signal incidence direction of path p.

The channel above is parametrized by three dimensions: frequency, spatial, and temporal dimensions. While for most scenarios/use cases the channel is assumed to be fixed for a long-enough interval of time to pursue CSI measurement, reporting and signal precoding via NR-based linear precoding techniques within the channel coherence time, this assumption may be revisited for other precoding techniques, e.g., AI/MLL-based techniques that require sharing the AI model parameters, for which the overhead can be tremendously large and hence would need to be carried out over a large number of slots. Note that a change in the channel behavior may be associated with a change of the UE orientation, a change of the UE line-of-site (LoS) condition, or a combination thereof. More specifically, assume a network with gNB-centric AI/NL training/modeling. While UEs within a coverage area of the network entity (e.g., gNB) may correspond to infinitely many instantaneous channel coefficient values, these channel coefficient values can be categorized under a finite number of channel distributions, e.g., based on region of UE location, indoor/outdoor UE status, LoS/NLoS UE status, or some combination thereof. Due to the large variation of the channel distributions a common model that is trained using a mixture of training data based on the aforementioned distribution may not be generalizable enough to provide high-resolution precoding for all distributions. In light of that, multiple training data sets that can be used to train multiple training models are needed for a higher resolution precoding.

In the discussions herein, a CSI framework that supports multiple AI/NIL models is discussed, where each AI/NL model corresponds to a distinct channel distribution. In order to support such a framework, a training data set may be partitioned into multiple training data sets, where each training data set is used to train a distinct AI/NIL model. Techniques of classifying and possibly sharing the training data set between the UE and the network, as well as selecting the AI/ML model and sharing the AI/ML model parameters and selections between the UE and the network will be discussed in further detail below. Furthermore, a second stage precoder adjustment is discussed, where the second stage precoder adjustment enables switching ON/OFF and/or scaling the amplitude corresponding to a subset of CSI-RS ports, a subset of indices of a transformed spatial domain, a transformed frequency domain, a transformed time domain, or a combination thereof. Several implementations that describe the aforementioned CSI framework are described below. One or more elements or features from one or more of the described implementations may be combined.

A description of the AI/NL model for CSI measurement and reporting follows. For AI/N-based CSI frameworks, multiple alternatives exist for the outline of the AI/NL algorithm functionality, as follows. In one or more implementations, the AI/NIL model is trained at the UE. This alternative may appear reasonable since the UE is the node that can seamlessly collect training data for CSI acquisition using downlink (DL) pilot signals, e.g., CSI-RSs for channel measurement, however, the AI/NIL model may be re-trained whenever the environment changes, e.g., change of the UE location or orientation and every training instance requires significant memory and computational complexity requirements.

Additionally or alternatively, the AI/NIL model is trained at the network entity. One advantage of this approach is that the network has significantly more power and computational capabilities compared with a UE, and hence can manage training moderately complex AI/ML models, as well as store large amounts of training data. Moreover, since a network node is mostly assumed to be fixed, its coverage area is expected to be the same and hence a single AI/ML model can be applicable to UEs within a specific region of the cell for a reasonable period of time. One challenge with this approach is related to obtaining the training data at the network node, especially for FDD systems in which the uplink (UL)/DL channel reciprocity may not hold. Note that the overhead corresponding to feeding back the training data from the UE to the network may be considered as one of the metrics when assessing the efficiency of an AI/ML algorithm.

Note that a series of model re-training events and their associated measurement configuration can be defined. For instance, in case of UE-based AI/ML, model training, the UE upon determining a significant change in one or more of parameters of a channel distribution over a measurement window can determine that a channel distribution change has occurred, and hence triggering model re-training. Additionally or alternatively, the network node upon determining a significant change in one or more of parameters of a channel distribution over a measurement window can determine that a channel distribution change has occurred, and hence triggering model re-training

In some discussions it is assumed the AI/ML model is trained at the network due to the advantages corresponding to memory, computation, and cell-centric characteristics of the network-based AI/ML model computation. The challenge corresponding to obtaining the training data corresponding to the DL channel at the network side is discussed below.

Assuming the AI/ML model is trained at the network, a few aspects of DL training data acquisition at the network side to enable efficient AI/ML modeling are discussed below. In one or more implementations, in order to maintain the robustness of the AI/ML, model with respect to channel variations, DL training data may be continuously fed back to the network to keep up with changes in the environment, e.g., traffic, weather, and mobile scatterers. Note that this may not necessarily correspond to online learning; even for an offline learning algorithm a framework for obtaining new training data corresponding to channel variations may be characterized. In one example, the UE is configured with (pseudo) periodic training periods, where the UE can feedback information which could help the network node adjust/update the AI/ML model parameters if needed. The feedback can be sent using configured grant PUSCH transmissions.

In one or more implementations, based on the current codebook-based DL CSI feedback schemes in NR, the CSI is compressed in at least one of the spatial domain, or the frequency domain, or both. One approach would be using the codebook-based CSI feedback, e.g., Type-I and/or Type-II codebooks for obtaining the training data. One disadvantage of this approach is that the training data would comprise CSI feedback that is already compressed via conventional approaches, which would have detrimental effect on the AI/MHL model inference accuracy. For instance, if the AI/ML model compares the output of the AI/ML model with the channel corresponding to the CSI feedback to assess its own inference accuracy, this assessment would not be precise since it is based on H′, an estimate of the channel based on a pre-defined compression, rather than H, a digitally quantized channel without further compression in spatial domain, or frequency domain. On the other hand, if the UE feeds back the training data corresponding to the DL CSI feedback without compression over spatial and/or frequency dimensions, the feedback overhead of the training data would be significant, which would beat the purpose of using the AI/NIL model, which is mainly to reduce the overall CSI feedback overhead. For example, numerically an AI/MHL-based CSI feedback aims at minimizing the following metric

$${min}_{\hat{H}} ‖ \hat{H} - H ‖$$

where H represents a digital-domain representation of the channel matrix. On the other hand, a compressed channel H′, which represents the recovered channel after codebook-based transformation, would yield the following optimization metric

$${min}_{\hat{H}} ‖ \hat{H} - {H}^{′} ‖$$

Since H≠H′, the output of both optimizations would yield different channel estimates.

For DL CSI acquisition in NR, whether the network operates in FDD mode or TDD mode, it is unlikely that AI/MIL would fully replace RS-based CSI feedback for high-resolution precoding design, since some channel parameters may vary from one time instant to another, without strong correlation across the two time instants, e.g., initial random phases of the channel. Given that, AI/IL-based CSI framework can be envisioned as a technique for further reducing the CSI feedback overhead compared with conventional methods, e.g., reduce the number of dominant spatial-domain basis indices, frequency/delay-domain basis indices, and time/Doppler-domain basis indices, after spatial domain transformation, frequency-domain transformation, and time-domain transformation, respectively. While current CSI feedback frameworks already provide CSI feedback overhead reduction via exploiting such transformations, the CSI dimensionality can be further reduced if a wider range of transformation techniques are pre-configured, where a different transformation may be selected for a given UE based on variations of the channel.

CSI feedback corresponding to a selection from multiple AI/ML models is discussed below. In the following implementations, a CSI feedback framework is proposed that enables generalized codebook reporting corresponding to a variety of channel conditions, e.g., UE location, indoor/outdoor UE status, LoS/NLoS UE status, or some combination thereof. Several implementations that describe the proposed CSI framework are provided below. One or more elements or features from one or more of the described implementations may be combined.

In one or more implementations, training data partitioned based on different channel conditions. A training dataset corresponding to CSI is partitioned into multiple subsets of training dataset, where each subset of the multiple subsets of the training dataset corresponds to a distinct channel condition. Several examples of partitioning the training data set are discussed in the following. In one example, the training dataset is partitioned based on a ratio of a channel gain of a strongest spatial domain index, e.g., CSI-RS port, to that of a second strongest spatial domain index. E.g., if the ratio is at or above a threshold value then the training dataset is in one subset, and if the ratio is below the threshold value then the training dataset is in another subset. Additionally or alternatively, the training dataset may be partitioned based on a ratio of a channel gain of the strongest spatial domain index to that of a remainder of the spatial domain indices.

In another example, the training dataset is partitioned based on a ratio of a channel gain of a strongest frequency domain index, to that of a second strongest frequency domain index. Additionally or alternatively, the training dataset may be partitioned based on a ratio of a channel gain of the strongest frequency domain index to that of a remainder of the frequency domain indices.

In another example, the training dataset is partitioned based on a location estimate of a UE, where a first UE whose estimated location is within a first region is partitioned into a first subset of the multiple subsets of the training dataset, and a second UE whose estimated location is within a second region is partitioned into a second subset of the multiple subsets of the training dataset.

In another example, the training dataset is partitioned based on a CSI-RS resource indicator (CRI) value corresponding to the UE, where a first UE whose corresponding CRI value is equal to a first value is partitioned into a first subset of the multiple subsets of the training dataset, and a second UE whose corresponding CRI value is equal to a second value is partitioned into a second subset of the multiple subsets of the training dataset.

In another example, a first subset of the multiple subsets at least contains a first number of elements (‘n1’), and a second subset of the multiple subsets at least contains a second number of elements (‘n2’) where the first number and the second number are configured or determined. Note that ‘n1’ and ‘n2’ may be related; for instance,

$$a < \frac{n 1}{n 2} < b .$$

Additionally or alternatively, in case the UE cannot provide a given number of training samples, e.g., ‘n1’, within a certain time window, the UE indicates such an event to the network.

In one or more implementations, the UE feeds back CSI to the network, where the fed back CSI corresponds to an AI/ML-based training dataset, and the CSI comprises a parameter corresponding to an indicator of a subset of the dataset from the multiple subsets of datasets. In one example, the parameter is included as part of a CSI report that is fed back to the network over one of PUSCH, PUCCH, where reporting the parameter is triggered, e.g., via DCI triggering a CSI report.

In another example, the indicator value is computed based on one of a fixed or higher-layer configured formula that is indicated by the network to enable a classification of the CSI to one of the multiple subsets of the training dataset.

In another example, an AI/ML model training or retraining event is triggered due to a change in a channel condition, and the UE notifies the network about the event via a first notification. The network or UE determines the subset of the dataset from the multiple subsets of datasets based on the first notification. The subset of the dataset is valid for a pre-determined duration of time or until another notification is received.

In another example, the CSI reporting setting associated with the CSI report includes a field which indicates if the CSI report is associated with an AI/ML model training.

In one or more implementations, the UE feeds back CSI corresponding to the training dataset, where an indicator of the subset of the training dataset to which the fed back CSI belongs is included as part of the CSI report. In one example, a field corresponding to the indicator is reported in the CSI report based on a configured report quantity of the CSI Reporting setting.

In another example, the indicator is implicit, e.g., not reported as a standalone parameter, and is instead inferred from an output value of a function that depends on coefficient values, spatial/frequency/time domain selected basis indices, e.g., based on an average gain corresponding to a group of coefficients corresponding to a subset of the dimensions.

In another example, at least one value of a set of possible indicator values may correspond to a case where the CSI cannot be classified to any subset of the multiple subsets of the training dataset. E.g., there may be an indication that none of the AI/ML models work efficiently for a channel.

In another example, the indicator value is based on multiple CSI-RS measurements, e.g., a sequence of CSI-RSs received over a periodic CSI-RS resource, or a semi-persistent CSI-RS resource configuration.

In one or more implementations, AI/ML model training is performed at the network side and shared with the UE. The network signals a set of parameters corresponding to multiple AI/ML models, e.g., encoder functions of a CSI auto-encoder, where the set of parameters are partitioned into multiple subsets of parameters, and each subset of parameters is associated with an AI/ML model of the multiple AI/ML models. In one example, the network signals the set of parameters as part of higher-layer, e.g., RRC signaling.

In another example, the network signals the set of parameters as part of an AI-based report over at least one of PUSCH, PUCCH.

In another example, the network signals a first subset of the set of parameters corresponding to a subset of the multiple AI/ML models in a first time unit, and feeds back a second subset of the set of parameters corresponding to a subset of the multiple AI/ML models in a subsequent time unit.

In another example, a subset of the set of parameters corresponding to a subset of the multiple AI/L models is common for multiple network nodes.

In another example, a subset of the set of parameters corresponding to a subset of the multiple AI/L models is signaled to the UE based on an indicator value reported by the UE that indicates a characteristic that corresponds to the subset of the multiple AI/ML models.

In one or more implementations, AI/ML model training is performed at the UE side and shared with the network. The UE signals a set of parameters corresponding to multiple AI/ML models, e.g., decoder functions of a CSI auto-encoder, where the set of parameters are partitioned into multiple subsets of parameters, each subset of parameters is associated with an AI/ML model of the multiple AI/ML models. In one example, the UE feeds back the set of parameters as part of a CSI report over at least one of PUSCH, PUCCH.

In another example, the UE feeds back the set of parameters as part of an AI-based report over at least one of PUSCH, PUCCH.

In another example, the UE feeds back a first subset of the set of parameters corresponding to a subset of the multiple AI/ML models in a first report, and feeds back a second subset of the set of parameters corresponding to a subset of the multiple AI/ML models in a second subsequent report.

In another example, the UE feeds back the set of parameters as part of higher-layer signaling.

In another example, a group of subsets of parameters is configured, and the UE provides the network with a set of parameters corresponding to each subset of the group of subsets of parameters.

In one or more implementations, the UE receives a configuration signal, e.g., as part of higher-layer configuration signaling, that indicates a CSI-based metric that the UE would compute to select an AI/ML model from the multiple AI/ML models. In one example, the CSI-based metric corresponds to a number of frequency-domain basis indices that is reported by the UE.

In another example, the CSI-based metric corresponds to a number of spatial-domain basis indices that is reported by the UE.

In another example, the CSI-based metric corresponds to a ratio of a function of power (or alternatively amplitude) gain of a first subset of spatial-domain basis indices to a function of power (or alternatively amplitude) gain of a second subset of spatial-domain basis indices.

In another example, the CSI-based metric corresponds to a ratio of a function of power (or alternatively amplitude) gain of a first subset of frequency-domain basis indices to a function of power (or alternatively amplitude) gain of a second subset of frequency-domain basis indices.

In one or more implementations, the network indicates to the UE an index of an AI/ML model from the multiple AI/ML, models based on uplink-downlink channel reciprocity. In one example, the network indicates signals an index of s selected AI/ML model as part of at least one of DCI signaling, MAC CE signaling, or RRC signaling. In another example, the uplink-downlink channel reciprocity corresponds to a sounding reference signal that is coupled with a CSI-RS resource via SRS resource configuration signaling as part of a higher-layer signaling.

In one or more implementations, the network indicates via a first indication the model parameters based on the training. The model parameters are applicable after a first certain time from a time reference associated with the first indication. The first certain time can be pre-determined, reported via a UE capability signaling, depends on a characteristic of training data set (e.g., related to a number of dominant channel paths). The UE does not expect to receive a second indication indicating (a second) model parameters prior to elapsing the first certain time.

CSI feedback adjustment based on a selected AI/ML model is discussed below. As discussed above, the CSI feedback may be mismatched compared with the possible channel variations/distributions represented in the multiple AI/MIL models, e.g., due to bursty interference, instantaneous hardware issues or instantaneous blockage. In light of that, some adjustment to the inferred output of the AI/ML model may be made to adjust with this instantaneous channel variation. Several implementations are described below. One or more elements or features from one or more of the described implementations may be combined.

In one or more implementations, the UE can switch off some beams based on some instantaneous channel variation that is not captured in the model. The UE feeds back a bitmap corresponding to at least one of channel/precoder spatial domain dimensions, frequency domain dimensions and time domain dimensions, where the bitmap indicates whether at least one of the aforementioned dimensions is turned off, i.e., coefficients corresponding to the aforementioned dimensions are given a zero amplitude value, even if the inferred value corresponding to the AI/ML model is non-zero.

In one or more implementations, UE can attenuate some beams based on some instantaneous channel variation that is not captured in the model. The UE feeds back a bitmap corresponding to at least one of channel/precoder spatial domain dimensions, frequency domain dimensions and time domain dimensions, where the bitmap indicates whether at least one of the aforementioned dimensions is scaled, e.g., coefficients corresponding to the aforementioned dimensions are given a scaled amplitude value, where the scaling is applied to the inferred values from the AI/ML, model.

In one or more implementations, UE can attenuate/switch off beams based on code book subset restriction (CBSR). The adjustment of amplitude values of the subset of coefficients is in a form of a UE feedback corresponding to codebook subset restriction feedback.

In one or more implementations, the adjustment of amplitude values is network-based, e.g., the network signals the adjustment.

In one or more implementations, the terms antenna, panel, and antenna panel are used interchangeably. An antenna panel may be a hardware that is used for transmitting and/or receiving radio signals at frequencies lower than 6 GHz, e.g., frequency range 1 (FRI), or higher than 6 GHz, e.g., frequency range 2 (FR2) or millimeter wave (mmWave). In some implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In one or more implementations, an antenna panel may or may not be virtualized as an antenna port. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. Capability information may be communicated via signaling or capability information may be provided to devices without a need for signaling. In the case that such information is available to other devices, it can be used for signaling or local decision making.

In one or more implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to the network entity (e.g., gNB). For certain condition(s), the network entity (e.g., gNB) or network can assume the mapping between device's physical antennas to the logical entity “device panel” may not be changed. For example, the condition may include until the next update or report from device or comprise a duration of time over which the network entity (e.g., gNB) assumes there will be no change to the mapping. A device may report its capability with respect to the “device panel” to the network entity (e.g., gNB) or network. The device capability may include at least the number of “device panels”. In one or more implementations, the device may support UL transmission from one beam within a panel; with multiple panels, more than one beam (one beam per panel) may be used for UL transmission. Additionally or alternatively, more than one beam per panel may be supported/used for UL transmission.

In one or more implementations, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g., the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive (RX) beamforming weights).

An “antenna port” according to one or more implementations may be a logical port that may correspond to a beam (resulting from beamforming) or may correspond to a physical antenna on a device. In one or more implementations, a physical antenna may map directly to a single antenna port, in which an antenna port corresponds to an actual physical antenna. Additionally or alternatively, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In one or more implementations, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of multiple transmission configuration indicator states for a serving cell for transmissions on the serving cell. In one or more implementations, a TCI state comprises at least one source RS to provide a reference (UE assumption) for determining QCL and/or spatial filter.

In one or more implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of multiple spatial relation information configurations for a serving cell for transmissions on the serving cell.

In one or more implementations, a UL TCI state is provided if a device is configured with separate DL/UL TCI by RRC signaling. The UL TCI state may comprises a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In one or more implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/physical downlink shared channel (PDSCH)) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Accordingly, the techniques discussed herein provide an AI-based CSI feedback mechanism that provides a channel-matching precoder under different channel conditions, e.g., LoS/NLoS, Outdoor/Indoor status of a UE, and so forth. In order to accommodate for such variations in channel conditions, some flexibility in the precoder design is used. More specifically, the UE is configured with multiple AI/ML models, where each AI/ML model of the multiple AI/ML models is based on a distinct data set corresponding to a distribution of the CSI, such that the UE can toggle between different precoder selections corresponding to different channel distributions based on variations in UE location, orientation, outdoor/indoor, LoS/NLoS status, and so forth. Signaling between the UE and the network that indicates a selected AI/ML, model from the plurality of AI/ML models based on a channel-based threshold is also discussed.

Additionally or alternatively, the UE is configured with reporting an indication that corresponds to switching off a subset of the set of ports, a subset of the set of frequency sub-bands, or a combination thereof, such that the precoder can be adjusted based on instantaneous deviation of the channel from its typical distribution, e.g., due to bursty interference or instantaneous blockage

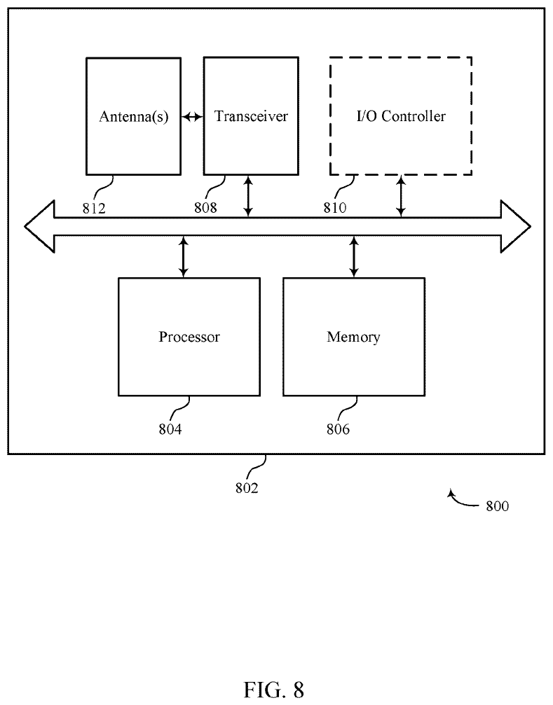

FIG. 8 illustrates an example of a block diagram 800 of a device 802 that supports generating a measurement report using one of multiple available artificial intelligence models in accordance with aspects of the present disclosure. The device 802 may be an example of a UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. Processor 804 may be configured as or otherwise support receive, from a network entity, a first signaling indicating a configuration for measurement and reporting of at least one quantity, the configuration indicating a set of reference signals for measurement of the at least one quantity and indicating to report one or more parameters corresponding to the at least one quantity; generate a measurement report, including the one or more parameters corresponding to the at least one quantity, based at least in part on the set of reference signals and a selection of an AI model from multiple AI models, each AI model of the multiple AI models having been configured prior to receiving the first signaling; and transmit, to the network entity, a second signaling indicating the measurement report.

Additionally or alternatively, the processor 804 may be configured to or otherwise support: where at least one of: the measurement report comprises a CSI measurement report; the configuration comprises a CSI reporting configuration message; the at least one quantity comprises a CSI quantity; and the set of reference signals comprises at least one CSI-RS received over a CSI-RS resource; where the selection of the AI model is based on at least one of: a number of frequency-domain basis indices corresponding to one of a precoding matrix or a channel matrix; a number of spatial-domain basis indices corresponding to one of a precoding matrix or a channel matrix; a ratio of a function of power gain of a first subset of the spatial-domain basis indices to a function of power gain of a second subset of the spatial-domain basis indices; and a ratio of a function of power gain of a first subset of the frequency-domain basis indices to a function of power gain of a second subset of the frequency-domain basis indices; where the at least one CSI-RS corresponds to multiple CSI-RS ports; where the processor is further configured to: receive, from the network entity, a third signaling indicating one or more parameters corresponding to the selection of the AI model from the multiple AI models; and generate the measurement report based at least in part on the AI model and the one or more parameters that correspond to the AI model; where the one or more parameters are at least one of: signaled via higher-layer signaling, signaled over multiple time units, and common for multiple network nodes; where the processor is further configured to: transmit, to the network entity, a third signaling indicating at least one parameter corresponding to the selection of the AI model from the multiple AI models; where the third signaling includes at least one of a CSI report or an AI-based report, and where the third signaling is transmitted over multiple time units; where the processor is further configured to: transmit, to the network entity, a third signaling indicating a set of parameters corresponding to a subset of coefficients associated with a subset of CSI dimensions having one or more coefficients including an adjusted value; where the set of parameters corresponds to a bitmap; where the adjusted value is zero; where the set of parameters corresponds to a set of amplitude values that includes a zero value; where the adjusted value is one of the set of amplitude values; where the set of parameters are adjusted based on a codebook subset restriction configuration.

For example, the processor 804 may support wireless communication at the device 802 in accordance with examples as disclosed herein. Processor 804 may be configured as or otherwise support a means for receiving, from a network entity, a first signaling indicating a configuration of an apparatus implementing the method for measurement and reporting of at least one quantity, the configuration indicating a set of reference signals for measurement of the at least one quantity and indicating to report one or more parameters corresponding to the at least one quantity; generating the measurement report, including the one or more parameters corresponding to the at least one quantity, based at least in part on the set of reference signals and a selection of an AI model from multiple AI models, each AI model of the multiple AI models having been configured prior to receiving the first signaling; and transmitting, to the network entity, a second signaling indicating the measurement report.

Additionally or alternatively, the processor 804 may be configured to or otherwise support: where at least one of: the measurement report comprises a CSI measurement report; the configuration comprises a CSI reporting configuration message; the at least one quantity comprises a CSI quantity; and the set of reference signals comprises at least one CSI-RS transmitted over a CSI-RS resource; where the selection of the AI model is based on at least one of: a number of frequency-domain basis indices corresponding to one of a precoding matrix or a channel matrix; a number of spatial-domain basis indices corresponding to one of a precoding matrix or a channel matrix; a ratio of a function of power gain of a first subset of the spatial-domain basis indices to a function of power gain of a second subset of the spatial-domain basis indices; and a ratio of a function of power gain of a first subset of the frequency-domain basis indices to a function of power gain of a second subset of the frequency-domain basis indices; where the at least one CSI-RS corresponds to multiple CSI-RS ports; receiving, from the network entity, a third signaling indicating one or more parameters corresponding to the selection of the AI model from the multiple AI models; and generating the measurement report based at least in part on the AI model and the one or more parameters that correspond to the one AI model; where the one or more parameters are at least one of. signaled via higher-layer signaling, signaled over multiple time units, and common for multiple network nodes; transmitting, to the network entity, a third signaling indicating at least one parameter corresponding to the selection of the AI model from the multiple AI models; where the third signaling includes at least one of a channel state information report or an AI-based report, and where the third signaling is transmitted over multiple time units; transmitting, to the network entity, a third signaling indicating a set of parameters corresponding to a subset of coefficients associated with a subset of CSI dimensions having one or more coefficients including an adjusted value; where the set of parameters corresponds to a bitmap; where the adjusted value is zero; where the set of parameters corresponds to a set of amplitude values that includes a zero value; where the adjusted value is one of the set of amplitude values; where the set of parameters are adjusted based on a codebook subset restriction configuration.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

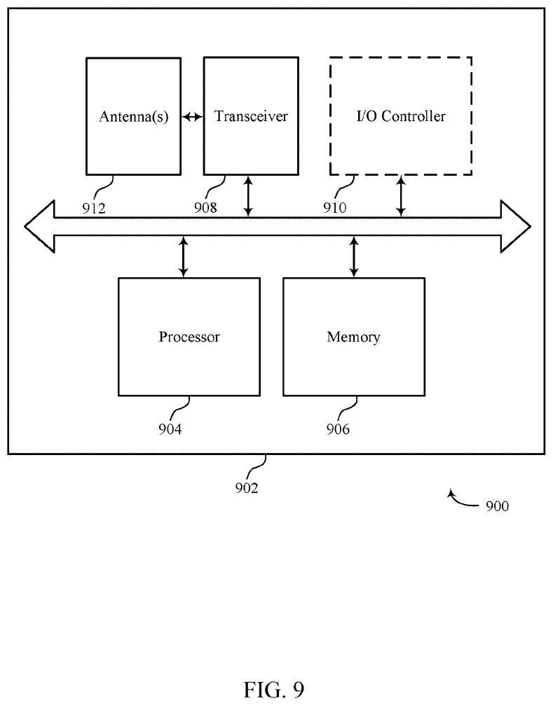

FIG. 9 illustrates an example of a block diagram 900 of a device 902 that supports generating a measurement report using one of multiple available artificial intelligence models in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. Processor 904 may be configured as or otherwise support transmit, to a UE, a first signaling indicating a configuration of the UE for measurement and reporting of at least one quantity, the configuration indicating a set of reference signals for measurement of the at least one quantity and indicating to report one or more parameters corresponding to the at least one quantity; and receive, from the UE, a second signaling indicating a measurement report, including the one or more parameters corresponding to the at least one quantity, generated based at least in part on the set of reference signals and a selection of an AI model from multiple AI models, each AI model of the multiple AI models having been configured prior to receiving the first signaling.

Additionally or alternatively, the processor 904 may be configured to or otherwise support: where at least one of: the measurement report comprises a CSI measurement report; the configuration comprises a CSI reporting configuration message; the at least one quantity comprises a CSI quantity; and the set of reference signals comprises at least one CSI-RS transmitted over a CSI-RS resource; where the selection of the AI model is based on at least one of: a number of frequency-domain basis indices corresponding to one of a precoding matrix or a channel matrix; a number of spatial-domain basis indices corresponding to one of a precoding matrix or a channel matrix; a ratio of a function of power gain of a first subset of the spatial-domain basis indices to a function of power gain of a second subset of the spatial-domain basis indices; and a ratio of a function of power gain of a first subset of the frequency-domain basis indices to a function of power gain of a second subset of the frequency-domain basis indices; where the at least one CSI-RS corresponds to multiple CSI-RS ports; transmit, to the UE, a third signaling indicating one or more parameters corresponding to the selection of the AI model from the multiple AI models; and receive, from the UE, the measurement report generated based at least in part on the AI model and the one or more parameters that correspond to the one AI model; where the one or more parameters are at least one of: signaled via higher-layer signaling, signaled over multiple time units, and common for multiple network nodes; receive, from the UE, third signaling indicating at least one parameter corresponding to the selection of the AI model from the multiple AI models; where the third signaling includes at least one of a channel state information report or an AI-based report, and where the third signaling is transmitted over multiple time units; receive, from the UE, third signaling indicating a set of parameters corresponding to a subset of coefficients associated with a subset of CSI dimensions having one or more coefficients including an adjusted value; where the set of parameters corresponds to a bitmap; where the adjusted value is zero; where the set of parameters corresponds to a set of amplitude values that includes a zero value; where the adjusted value is one of the set of amplitude values; where the set of parameters are adjusted based on a codebook subset restriction configuration.

For example, the processor 904 may support wireless communication at the device 902 in accordance with examples as disclosed herein. Processor 904 may be configured as or otherwise support a means for transmitting, to a UE, a first signaling indicating a configuration of the UE for measurement and reporting of at least one quantity, the configuration indicating a set of reference signals for measurement of the at least one quantity and indicating to report a measurement report that includes one or more parameters corresponding to the at least one quantity; and receiving, from the UE, a second signaling indicating a measurement report, including the one or more parameters corresponding to the at least one quantity, generated based at least in part on the set of reference signals and a selection of an AI model from multiple AI models, each AI model of the multiple AI models having been configured prior to receiving the first signaling.

Additionally or alternatively, the processor 904 may be configured to or otherwise support: where at least one of: the measurement report comprises a CSI measurement report; the configuration comprises a CSI reporting configuration message; the at least one quantity comprises a CSI quantity; and the set of reference signals comprises at least one CSI-RS transmitted over a CSI-RS resource; where the selection of the AI model is based on at least one of: a number of frequency-domain basis indices corresponding to one of a precoding matrix or a channel matrix; a number of spatial-domain basis indices corresponding to one of a precoding matrix or a channel matrix; a ratio of a function of power gain of a first subset of the spatial-domain basis indices to a function of power gain of a second subset of the spatial-domain basis indices; and a ratio of a function of power gain of a first subset of the frequency-domain basis indices to a function of power gain of a second subset of the frequency-domain basis indices; where the at least one CSI-RS corresponds to multiple CSI-RS ports; transmitting, to the UE, a third signaling indicating one or more parameters corresponding to the selection of the AI model from the multiple AI models; and receiving, from the UE, the measurement report generated based at least in part on the AI model and the one or more parameters that correspond to the one AI model; where the one or more parameters are at least one of: signaled via higher-layer signaling, signaled over multiple time units, and common for multiple network nodes; receiving, from the UE, third signaling indicating at least one parameter corresponding to the selection of the AI model from the multiple AI models; where the third signaling includes at least one of a channel state information report or an AI-based report, and where the third signaling is transmitted over multiple time units; receiving, from the UE, third signaling indicating a set of parameters corresponding to a subset of coefficients associated with a subset of CSI dimensions having one or more coefficients including an adjusted value; where the set of parameters corresponds to a bitmap; where the adjusted value is zero; where the set of parameters corresponds to a set of amplitude values that includes a zero value; where the adjusted value is one of the set of amplitude values; where the set of parameters are adjusted based on a codebook subset restriction configuration.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

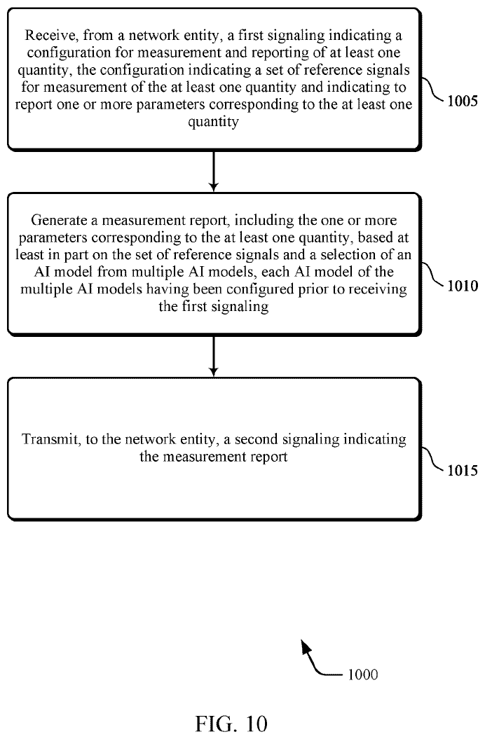

FIG. 10 illustrates a flowchart of a method 1000 that supports generating a measurement report using one of multiple available artificial intelligence models in accordance with aspects of the present disclosure. The operations of the method 1000 may be implemented by a device or its components as described herein. For example, the operations of the method 1000 may be performed by a UE 104 as described with reference to FIGS. 1-9. In some implementations, the device may execute a set of instructions to control the function elements of the device to perform the described functions. Additionally, or alternatively, the device may perform aspects of the described functions using special-purpose hardware.

At 1005, the method may include receiving, from a network entity, a first signaling indicating a configuration for measurement and reporting of at least one quantity, the configuration indicating a set of reference signals for measurement of the at least one quantity and indicating to report one or more parameters corresponding to the at least one quantity. The operations of 1005 may be performed in accordance with examples as described herein. In some implementations, aspects of the operations of 1005 may be performed by a device as described with reference to FIG. 1.

At 1010, the method may include generating a measurement report, including the one or more parameters corresponding to the at least one quantity, based at least in part on the set of reference signals and a selection of an AI model from multiple AI models, each AI model of the multiple AI models having been configured prior to receiving the first signaling. The operations of 1010 may be performed in accordance with examples as described herein. In some implementations, aspects of the operations of 1010 may be performed by a device as described with reference to FIG. 1.

At 1015, the method may include transmitting, to the network entity, a second signaling indicating the measurement report. The operations of 1015 may be performed in accordance with examples as described herein. In some implementations, aspects of the operations of 1015 may be performed by a device as described with reference to FIG. 1.

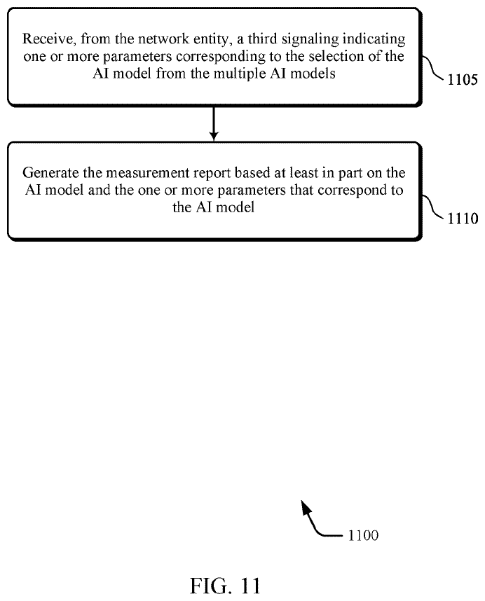

FIG. 11 illustrates a flowchart of a method 1100 that supports generating a measurement report using one of multiple available artificial intelligence models in accordance with aspects of the present disclosure. The operations of the method 1100 may be implemented by a device or its components as described herein. For example, the operations of the method 1100 may be performed by a UE 104 as described with reference to FIGS. 1-9. In some implementations, the device may execute a set of instructions to control the function elements of the device to perform the described functions. Additionally, or alternatively, the device may perform aspects of the described functions using special-purpose hardware.

At 1105, the method may include receiving, from the network entity, a third signaling indicating one or more parameters corresponding to the selection of the AI model from the multiple AI models. The operations of 1105 may be performed in accordance with examples as described herein. In some implementations, aspects of the operations of 1105 may be performed by a device as described with reference to FIG. 1.

At 1110, the method may include generating the measurement report based at least in part on the AI model and the one or more parameters that correspond to the AI model. The operations of 1110 may be performed in accordance with examples as described herein. In some implementations, aspects of the operations of 1110 may be performed by a device as described with reference to FIG. 1.

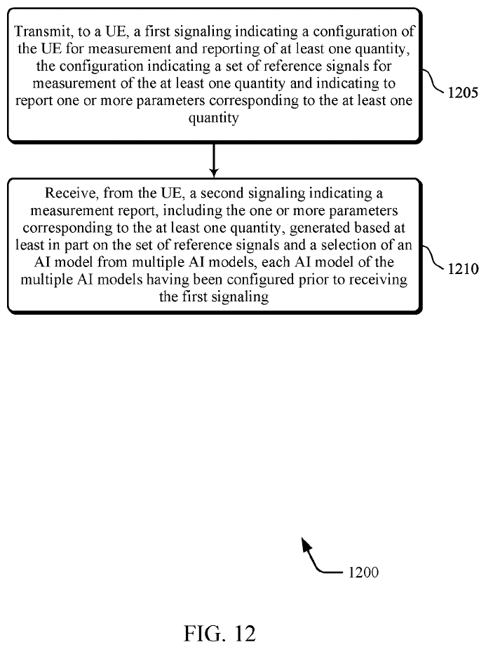

FIG. 12 illustrates a flowchart of a method 1200 that supports generating a measurement report using one of multiple available artificial intelligence models in accordance with aspects of the present disclosure. The operations of the method 1200 may be implemented by a device or its components as described herein. For example, the operations of the method 1200 may be performed by a network entity 102 as described with reference to FIGS. 1-9. In some implementations, the device may execute a set of instructions to control the function elements of the device to perform the described functions. Additionally, or alternatively, the device may perform aspects of the described functions using special-purpose hardware.

At 1205, the method may include transmitting, to a UE, a first signaling indicating a configuration of the UE for measurement and reporting of at least one quantity, the configuration indicating a set of reference signals for measurement of the at least one quantity and indicating to report one or more parameters corresponding to the at least one quantity. The operations of 1205 may be performed in accordance with examples as described herein. In some implementations, aspects of the operations of 1205 may be performed by a device as described with reference to FIG. 1.

At 1210, the method may include receiving, from the UE, a second signaling indicating a measurement report, including the one or more parameters corresponding to the at least one quantity, generated based at least in part on the set of reference signals and a selection of an AI model from multiple AI models, each AI model of the multiple AI models having been configured prior to receiving the first signaling. The operations of 1210 may be performed in accordance with examples as described herein. In some implementations, aspects of the operations of 1210 may be performed by a device as described with reference to FIG. 1.

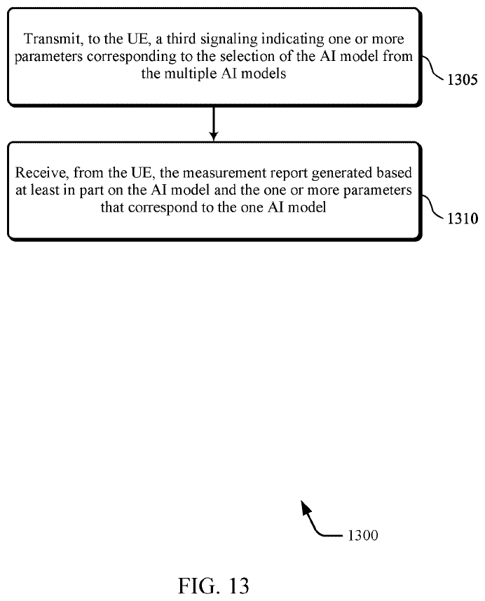

FIG. 13 illustrates a flowchart of a method 1300 that supports generating a measurement report using one of multiple available artificial intelligence models in accordance with aspects of the present disclosure. The operations of the method 1300 may be implemented by a device or its components as described herein. For example, the operations of the method 1300 may be performed by a network entity 102 as described with reference to FIGS. 1-9. In some implementations, the device may execute a set of instructions to control the function elements of the device to perform the described functions. Additionally, or alternatively, the device may perform aspects of the described functions using special-purpose hardware.

At 1305, the method may include transmitting, to the UE, a third signaling indicating one or more parameters corresponding to the selection of the AI model from the multiple AI models. The operations of 1305 may be performed in accordance with examples as described herein. In some implementations, aspects of the operations of 1305 may be performed by a device as described with reference to FIG. 1.

At 1310, the method may include receiving, from the UE, the measurement report generated based at least in part on the AI model and the one or more parameters that correspond to the one AI model. The operations of 1310 may be performed in accordance with examples as described herein. In some implementations, aspects of the operations of 1310 may be performed by a device as described with reference to FIG. 1.

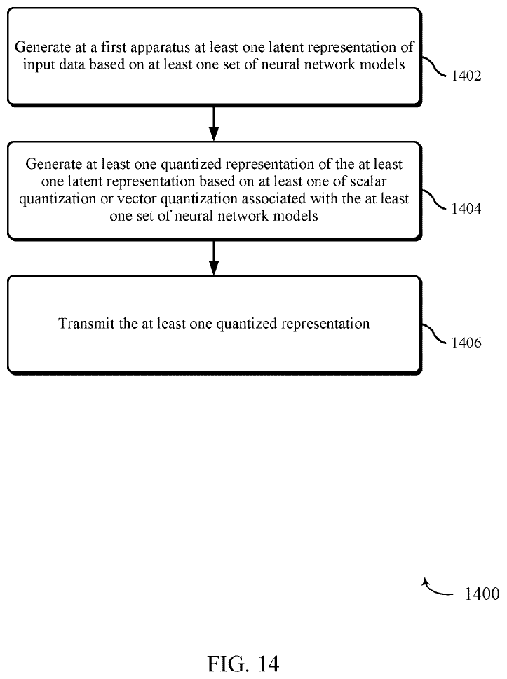

FIG. 14 illustrates a flowchart of a method 1400 that supports AI for CSI in accordance with aspects of the present disclosure. The operations of the method 1400 may be implemented by a device or its components as described herein. For example, the operations of the method 1400 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1402, the method may include generating at a first apparatus at least one latent representation of input data based on at least one set of neural network models. The operations of 1402 may be performed in accordance with examples as described herein. In some implementations, aspects of the operations of 1402 may be performed by a device as described with reference to FIG. 1.

At 1404, the method may include generating at least one quantized representation of the at least one latent representation based on at least one of scalar quantization or vector quantization associated with the at least one set of neural network models. The operations of 1404 may be performed in accordance with examples as described herein. In some implementations, aspects of the operations of 1404 may be performed by a device as described with reference to FIG. 1.

At 1406, the method may include transmitting the at least one quantized representation. The operations of 1406 may be performed in accordance with examples as described herein. In some implementations, aspects of the operations of 1406 may be performed by a device as described with reference to FIG. 1.

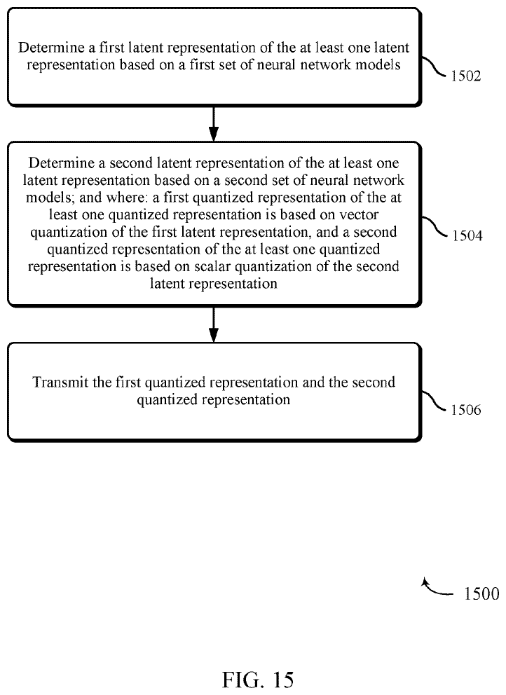

FIG. 15 illustrates a flowchart of a method 1500 that supports AI for CSI in accordance with aspects of the present disclosure. The operations of the method 1500 may be implemented by a device or its components as described herein. For example, the operations of the method 1500 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1502, the method may include determining a first latent representation of the at least one latent representation based on a first set of neural network models. The operations of 1502 may be performed in accordance with examples as described herein. In some implementations, aspects of the operations of 1502 may be performed by a device as described with reference to FIG. 1.

At 1504, the method may include determining a second latent representation of the at least one latent representation based on a second set of neural network models; and where: a first quantized representation of the at least one quantized representation is based on vector quantization of the first latent representation, and a second quantized representation of the at least one quantized representation is based on scalar quantization of the second latent representation. The operations of 1504 may be performed in accordance with examples as described herein. In some implementations, aspects of the operations of 1504 may be performed by a device as described with reference to FIG. 1.

At 1506, the method may include transmitting the first quantized representation and the second quantized representation. The operations of 1506 may be performed in accordance with examples as described herein. In some implementations, aspects of the operations of 1506 may be performed by a device as described with reference to FIG. 1.

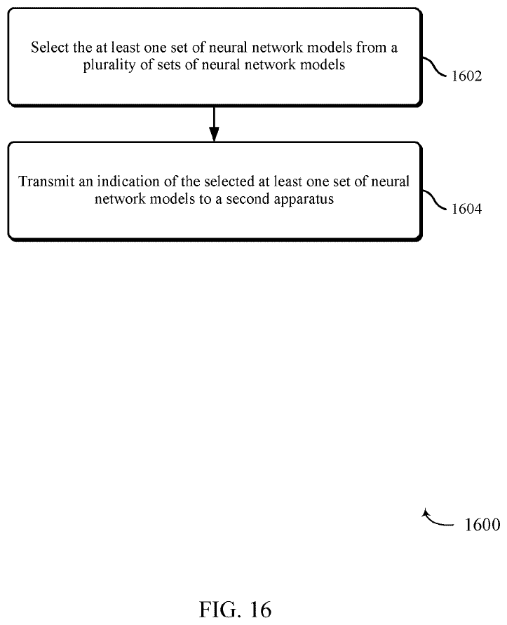

FIG. 16 illustrates a flowchart of a method 1600 that supports AI for CSI in accordance with aspects of the present disclosure. The operations of the method 1600 may be implemented by a device or its components as described herein. For example, the operations of the method 1600 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1602, the method may include selecting the at least one set of neural network models from a plurality of sets of neural network models. The operations of 1602 may be performed in accordance with examples as described herein. In some implementations, aspects of the operations of 1602 may be performed by a device as described with reference to FIG. 1.

At 1604, the method may include transmitting an indication of the selected at least one set of neural network models to a second apparatus. The operations of 1604 may be performed in accordance with examples as described herein. In some implementations, aspects of the operations of 1604 may be performed by a device as described with reference to FIG. 1.

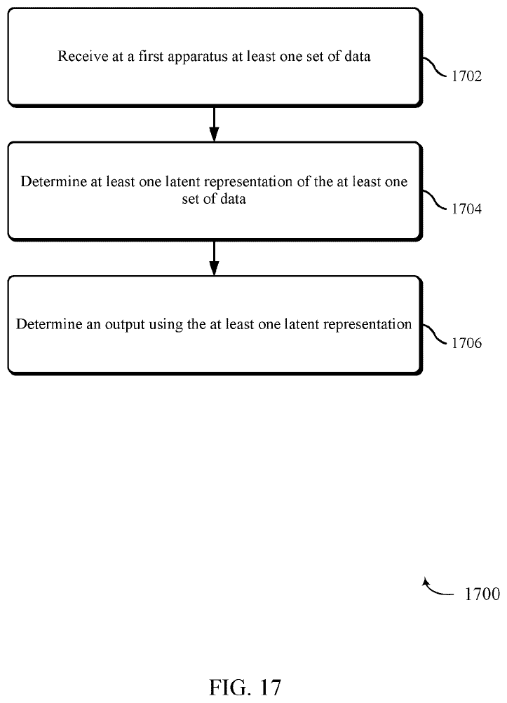

FIG. 17 illustrates a flowchart of a method 1700 that supports AI for CSI in accordance with aspects of the present disclosure. The operations of the method 1700 may be implemented by a device or its components as described herein. For example, the operations of the method 1700 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1702, the method may include receiving at a first apparatus at least one set of data. The operations of 1702 may be performed in accordance with examples as described herein. In some implementations, aspects of the operations of 1702 may be performed by a device as described with reference to FIG. 1.

At 1704, the method may include determining at least one latent representation of the at least one set of data. The operations of 1704 may be performed in accordance with examples as described herein. In some implementations, aspects of the operations of 1704 may be performed by a device as described with reference to FIG. 1.

At 1706, the method may include determining an output using the at least one latent representation. The operations of 1706 may be performed in accordance with examples as described herein. In some implementations, aspects of the operations of 1706 may be performed by a device as described with reference to FIG. 1.

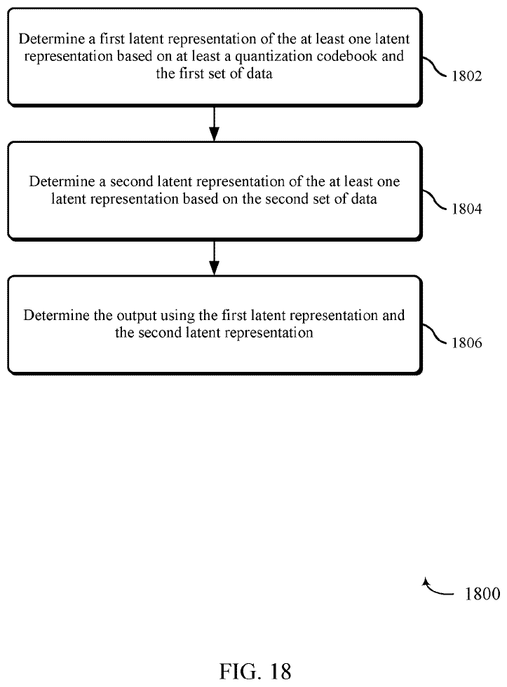

FIG. 18 illustrates a flowchart of a method 1800 that supports AI for CSI in accordance with aspects of the present disclosure. The operations of the method 1800 may be implemented by a device or its components as described herein. For example, the operations of the method 1800 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1802, the method may include determining a first latent representation of the at least one latent representation based on at least a quantization codebook and the first set of data. The operations of 1802 may be performed in accordance with examples as described herein. In some implementations, aspects of the operations of 1802 may be performed by a device as described with reference to FIG. 1.

At 1804, the method may include determining a second latent representation of the at least one latent representation based on the second set of data. The operations of 1804 may be performed in accordance with examples as described herein. In some implementations, aspects of the operations of 1804 may be performed by a device as described with reference to FIG. 1.

At 1806, the method may include determining the output using the first latent representation and the second latent representation. The operations of 1806 may be performed in accordance with examples as described herein. In some implementations, aspects of the operations of 1806 may be performed by a device as described with reference to FIG. 1.

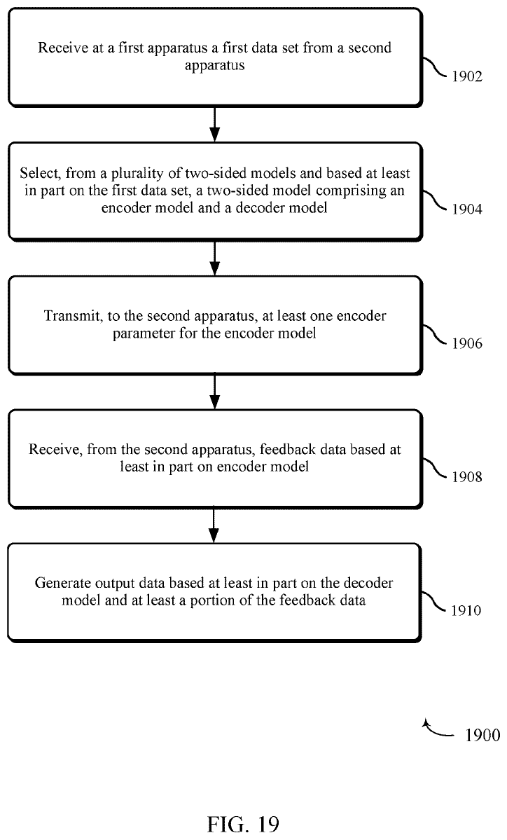

FIG. 19 illustrates a flowchart of a method 1900 that supports AI for CSI in accordance with aspects of the present disclosure. The operations of the method 1900 may be implemented by a device or its components as described herein. For example, the operations of the method 1900 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1902, the method may include receiving at a first apparatus a first data set from a second apparatus. The operations of 1902 may be performed in accordance with examples as described herein. In some implementations, aspects of the operations of 1902 may be performed by a device as described with reference to FIG. 1.

At 1904, the method may include selecting, from a plurality of two-sided models and based at least in part on the first data set, a two-sided model comprising an encoder model and a decoder model. The operations of 1904 may be performed in accordance with examples as described herein. In some implementations, aspects of the operations of 1904 may be performed by a device as described with reference to FIG. 1.

At 1906, the method may include transmitting, to the second apparatus, at least one encoder parameter for the encoder model. The operations of 1906 may be performed in accordance with examples as described herein. In some implementations, aspects of the operations of 1906 may be performed by a device as described with reference to FIG. 1.

At 1908, the method may include receiving, from the second apparatus, feedback data based at least in part on encoder model. The operations of 1908 may be performed in accordance with examples as described herein. In some implementations, aspects of the operations of 1908 may be performed by a device as described with reference to FIG. 1.

At 1910, the method may include generating output data based at least in part on the decoder model and at least a portion of the feedback data. The operations of 1910 may be performed in accordance with examples as described herein. In some implementations, aspects of the operations of 1910 may be performed by a device as described with reference to FIG. 1.

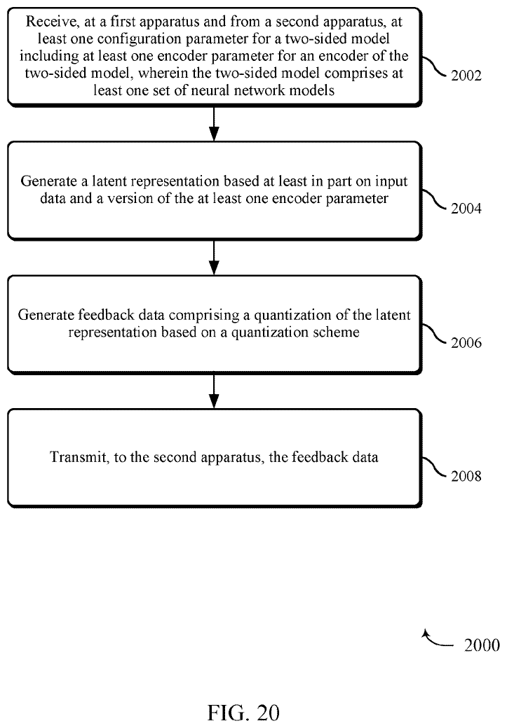

FIG. 20 illustrates a flowchart of a method 2000 that supports AI for CSI in accordance with aspects of the present disclosure. The operations of the method 2000 may be implemented by a device or its components as described herein. For example, the operations of the method 2000 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 2002, the method may include receiving, at a first apparatus and from a second apparatus, at least one configuration parameter for a two-sided model including at least one encoder parameter for an encoder of the two-sided model, wherein the two-sided model comprises at least one set of neural network models. The operations of 2002 may be performed in accordance with examples as described herein. In some implementations, aspects of the operations of 2002 may be performed by a device as described with reference to FIG. 1.

At 2004, the method may include generating a latent representation based at least in part on input data and a version of the at least one encoder parameter. The operations of 2004 may be performed in accordance with examples as described herein. In some implementations, aspects of the operations of 2004 may be performed by a device as described with reference to FIG. 1.

At 2006, the method may include generating feedback data comprising a quantization of the latent representation based on a quantization scheme. The operations of 2006 may be performed in accordance with examples as described herein. In some implementations, aspects of the operations of 2006 may be performed by a device as described with reference to FIG. 1.

At 2008, the method may include transmitting, to the second apparatus, the feedback data. The operations of 2008 may be performed in accordance with examples as described herein. In some implementations, aspects of the operations of 2008 may be performed by a device as described with reference to FIG. 1.

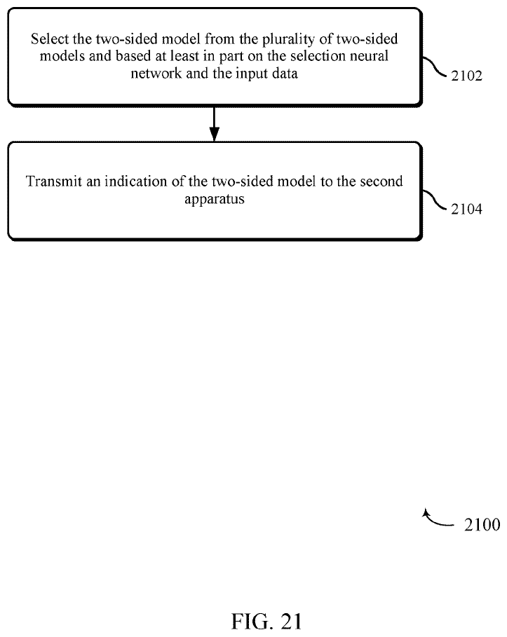

FIG. 21 illustrates a flowchart of a method 2100 that supports AI for CSI in accordance with aspects of the present disclosure. The operations of the method 2100 may be implemented by a device or its components as described herein. For example, the operations of the method 2100 may be performed by a UE 104 such as described with reference to FIGS. 1 through 9. In some implementations, the device may execute a set of instructions to control the function elements of the device to perform the described functions. Additionally, or alternatively, the device may perform aspects of the described functions using special-purpose hardware.

At 2102, the method may include selecting the two-sided model from the plurality of two-sided models and based at least in part on the selection neural network and the input data. The operations of 2102 may be performed in accordance with examples as described herein. In some implementations, aspects of the operations of 2102 may be performed by a device as described with reference to FIG. 1.

At 2104, the method may include transmitting an indication of the two-sided model to the second apparatus. The operations of 2104 may be performed in accordance with examples as described herein. In some implementations, aspects of the operations of 2104 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, a first signaling indicating a configuration for measurement and reporting of at least one quantity, the configuration indicating a set of reference signals for measurement of the at least one quantity and indicating to report one or more parameters corresponding to the at least one quantity;
generate a measurement report, including the one or more parameters corresponding to the at least one quantity, based at least in part on the set of reference signals and a selection of an artificial intelligence (AI) model from multiple AI models, each AI model of the multiple AI models having been configured prior to receiving the first signaling; and
transmit, to the network entity, a second signaling indicating the measurement report.

2. The UE of claim 1, wherein at least one of:
the measurement report comprises a channel state information (CSI) measurement report;
the configuration comprises a CSI reporting configuration message;
the at least one quantity comprises a CSI quantity; and
the set of reference signals comprises at least one CSI reference signal (CSI-RS) received over a CSI-RS resource.

3. The UE of claim 2, wherein the selection of the AI model is based on at least one of:
a number of frequency-domain basis indices corresponding to one of a precoding matrix or a channel matrix;
a number of spatial-domain basis indices corresponding to one of a precoding matrix or a channel matrix;
a ratio of a function of power gain of a first subset of the spatial-domain basis indices to a function of power gain of a second subset of the spatial-domain basis indices; and
a ratio of a function of power gain of a first subset of the frequency-domain basis indices to a function of power gain of a second subset of the frequency-domain basis indices.

4. The UE of claim 2, wherein the at least one CSI-RS corresponds to multiple CSI-RS ports.

5. The UE of claim 1, wherein the at least one processor is configured to cause the UE to:
receive, from the network entity, a third signaling indicating one or more parameters corresponding to the selection of the AI model from the multiple AI models; and
generate the measurement report based at least in part on the AI model and the one or more parameters that correspond to the AI model.

6. The UE of claim 5, wherein the one or more parameters are at least one of: signaled via higher-layer signaling, signaled over multiple time units, and common for multiple network nodes.

7. The UE of claim 1, wherein the at least one processor is configured to cause the UE to:
transmit, to the network entity, a third signaling indicating at least one parameter corresponding to the selection of the AI model from the multiple AI models.

8. The UE of claim 7, wherein the third signaling includes at least one of a channel state information (CSI) report or an AI-based report, and wherein the third signaling is transmitted over multiple time units.

9. The UE of claim 1, wherein the at least one processor is configured to cause the UE to:
transmit, to the network entity, a third signaling indicating a set of parameters corresponding to a subset of coefficients associated with a subset of channel state information (CSI) dimensions having one or more coefficients comprising an adjusted value.

10. The UE of claim 9, wherein the set of parameters corresponds to a bitmap.

11. The UE of claim 9, wherein the adjusted value is zero.

12. The UE of claim 9, wherein the set of parameters corresponds to a set of amplitude values that includes a zero value.

13. The UE of claim 12, wherein the adjusted value is one of the set of amplitude values.

14. The UE of claim 9, wherein the set of parameters are adjusted based on a codebook subset restriction configuration.

15. A base station for wireless communication, comprising:
at least one memory; and
at least one processor coupled with the at least one memory and configured to cause the base station to:
transmit, to a user equipment (UE), a first signaling indicating a configuration of the UE for measurement and reporting of at least one quantity, the configuration indicating a set of reference signals for measurement of the at least one quantity and indicating to report one or more parameters corresponding to the at least one quantity; and
receive, from the UE, a second signaling indicating a measurement report, including the one or more parameters corresponding to the at least one quantity, generated based at least in part on the set of reference signals and a selection of an artificial intelligence (AI) model from multiple AI models, each AI model of the multiple AI models having been configured prior to receiving the first signaling.

16. A method performed by a user equipment (UE), the method comprising:
receiving, from a network entity, a first signaling indicating a configuration of an apparatus implementing the method for measurement and reporting of at least one quantity, the configuration indicating a set of reference signals for measurement of the at least one quantity and indicating to report one or more parameters corresponding to the at least one quantity;
generating the measurement report, including the one or more parameters corresponding to the at least one quantity, based at least in part on the set of reference signals and a selection of an artificial intelligence (AI) model from multiple AI models, each AI model of the multiple AI models having been configured prior to receiving the first signaling; and
transmitting, to the network entity, a second signaling indicating the measurement report.

17. A processor for wireless communication, comprising:
at least one controller coupled with at least one memory and configured to cause the processor to:
receive, from a network entity, a first signaling indicating a configuration for measurement and reporting of at least one quantity, the configuration indicating a set of reference signals for measurement of the at least one quantity and indicating to report one or more parameters corresponding to the at least one quantity;
generate a measurement report, including the one or more parameters corresponding to the at least one quantity, based at least in part on the set of reference signals and a selection of an artificial intelligence (AI) model from multiple AI models, each AI model of the multiple AI models having been configured prior to receiving the first signaling; and
transmit, to the network entity, a second signaling indicating the measurement report.

18. The processor of claim 17, wherein at least one of:
the measurement report comprises a channel state information (CSI) measurement report;
the configuration comprises a CSI reporting configuration message;
the at least one quantity comprises a CSI quantity; and
the set of reference signals comprises at least one CSI reference signal (CSI-RS) received over a CSI-RS resource.

19. The processor of claim 17, wherein the at least one controller is configured to cause the processor to:
receive, from the network entity, a third signaling indicating one or more parameters corresponding to the selection of the AI model from the multiple AI models; and
generate the measurement report based at least in part on the AI model and the one or more parameters that correspond to the AI model.

20. The processor of claim 17, wherein the at least one controller is configured to cause the processor to:
transmit, to the network entity, a third signaling indicating at least one parameter corresponding to the selection of the AI model from the multiple AI models.
